(19) United States
(12) Patent Application Publication
(10) Pub. No.: US 2021/0299596 A1
(43) Pub. Date: Sep. 30, 2021

(54) WATER FILTER AUTHENTICATION SYSTEM

(71) Applicant: ELECTROLUX HOME PRODUCTS, INC., Charlotte, NC (US)

(72) Inventors: Thomas W. McCollough, Anderson, SC (US); William Thomas Anniss, III, Simpsonville, SC (US); Willard Grant, Williamston, SC (US); Raony Barrios, Anderson, SC (US); William L. Small, Belton, SC (US); Marcello Correa Machado, Anderson, SC (US); Christopher Stephan Rousey, Anderson, SC (US); Ken Brandt, Greenville, SC (US); Marcelo C. Candeo, Piedmont, SC (US); Ramesh Subramanian, Charlotte, NC (US); Robert Astle, Middlefield, CT (US); George Nicholas Lauri, III, Windsor, CT (US); Chong Hun Yi, Mechanicsburg, PA (US); Brian Keith Weaver, Harrisburg, PA (US); William James Moyer, II, Selinsgrove, PA (US); Ronald Skovira, Carlisle, PA (US); Gary Altemose, Harrisburg, PA (US); Richard Benjamin Emenheiser, Mount Joy, PA (US)

(73) Assignee: ELECTROLUX HOME PRODUCTS, INC., Charlotte, NC (US)

(21) Appl. No.: 17/344,087

(22) Filed: Jun. 10, 2021

Related U.S. Application Data
(62) Division of application No. 16/687,246, filed on Nov. 18, 2019.
Application No. 16/687,246 is a continuation-in-part of application No. PCT/US2019/051076, filed on Sep. 13, 2019.
Application No. PCT/US2019/051076 is a continuation-in-part of application No. 16/566,931, filed on Sep. 11, 2019, now Pat. No. 11,031,710.
(60) Provisional application No. 62/730,787, filed on Sep. 13, 2018.

(51) Int. Cl. B01D 35/143; C02F 1/00; G06F 21/44

(52) U.S. Cl. CPC B01D 35/1435; C02F 1/003; C02F 2201/006; B01D 2201/56; G06F 21/44

(57) ABSTRACT

An authentication system for authenticating a water filter cartridge at an appliance is provided. The water filter cartridge comprises a connection assembly having one or more connection devices that are structured for engaging an electrical connector of an appliance water filter manifold assembly of an appliance, to establish an electrical connection between the connection assembly and a controller of the appliance. A method of use of the water filter cartridge at the appliance comprises inserting the water filter cartridge into a receptacle of an appliance water filter manifold assembly. A method of authentication of the water filter cartridge comprises establishing an electrical communication link between a memory device of a water filter cartridge and an appliance water filter manifold assembly of the appliance, and retrieving, via the electrical communication link, a unique identifier associated with the water filter cartridge from the memory device.

### CROSS-REFERENCE TO PRIORITY APPLICATIONS

This application is divisional application of and claims priority to co-pending U.S. Non-Provisional patent application Ser. No. 16/687,246 entitled “Water Filter Authentication System” filed on Nov. 18, 2019 and published as U.S. Application Publication No. 2020/0086248A1, which itself is a continuation-in-part of PCT Application Ser. No. PCT/US2019/051076 entitled “Water Filter Authentication System,” filed on Sep. 13, 2019 and published as PCT Publication No. WO 2020/056305, which itself claims the benefit of U.S. Non-Provisional patent application Ser. No. 16/566,931 entitled “Electrical Connector and Wire Harness Assembly with Compression Contacts” filed on Sep. 11, 2019 and published as U.S. Application Publication No. 2020/0091638A1, and U.S. Provisional Patent Application Ser. No. 62/730,787 entitled “Electrical Connector and Wire Harness Assembly with Compression Contacts” filed on Sep. 13, 2018, all of which are hereby incorporated by reference in their entirety.

### FIELD OF THE INVENTION

In general, the present invention is directed to authentication of replaceable water filters utilized in appliances. Specifically, in some embodiments, the present invention is directed to a water filter cartridge that is structured to engage an electrical connector and wire harness assembly for connecting to a substrate. In some embodiments, the invention is directed to an electrical connector and wire harness assembly which has contacts which compress when mated to a substrate. Moreover, in some embodiments, the present invention is directed to a method of use of the water filter cartridge and a method of authenticating the water filter cartridge.

### BACKGROUND

Various consumer appliances such as refrigerators utilize water filters to filter and/or purify water utilized by or dispensed by the appliance. These water filters typically take the form of replaceable water filters, which need to be replaced upon expiration.

### BRIEF SUMMARY

The following presents a simplified summary of one or more embodiments of the invention in order to provide a basic understanding of such embodiments. This summary is not an extensive overview of all contemplated embodiments, and is intended to neither identify key or critical elements of all embodiments, nor delineate the scope of any or all embodiments. Its sole purpose is to present some concepts of one or more embodiments in a simplified form as a prelude to the more detailed description that is presented later.

The invention provides apparatuses and methods of use and authentication of a water filter cartridge. In particular, in some embodiments of the invention, a water filter cartridge is provided. Typically, the water filter cartridge comprises a connection assembly. The connection assembly comprises one or more connection devices structured for engaging an electrical connector of an appliance water filter manifold assembly of an appliance, to establish an electrical connection between the connection assembly and a controller of the appliance. Typically, the one or more connection devices are structured to be positioned in mechanical and electrical engagement with curved contact sections of substrate engagement sections of one or more contacts of the electrical connector, wherein the substrate engagement sections extend from compliant sections of the one or more contacts, wherein the compliant sections extend from termination sections of the one or more contacts, wherein the termination sections are connected to a surface of the electrical connector.

In some embodiments or in combination with any of the previous embodiments, the connection assembly further comprises a memory device structured to store a unique identifier associated with the water filter cartridge.

In some embodiments or in combination with any of the previous embodiments, the connection assembly comprises a connection body having a recess enclosing the memory device.

In some embodiments or in combination with any of the previous embodiments, the one or more connection devices are positioned at a first surface of the connection body, and the memory device is positioned proximate a second surface opposite the first surface.

In some embodiments or in combination with any of the previous embodiments, the memory device is a microchip or an integrated circuit.

In some embodiments or in combination with any of the previous embodiments, the connection assembly comprises an electronic circuit component that electrically connects the one or more connection devices and the memory device.

In some embodiments or in combination with any of the previous embodiments, the electronic circuit component is a printed circuit board.

In some embodiments or in combination with any of the previous embodiments, the one or more connection devices comprise (i) a first connection device structured to engage a first contact of the one or more contacts and (ii) a second connection device structured to engage a second contact of the one or more contacts. Typically, the first connection device is positioned at a spatial distance from the second connection device such that flexing of the one or more contacts does not cause an electrical short circuit of the one or more connection devices.

In some embodiments or in combination with any of the previous embodiments, each of the one or more connection devices comprise a connection surface structured such that the connection surface maintains an engagement with the one or more contacts during flexing of the one or more contacts from a first position to a second position.

In some embodiments or in combination with any of the previous embodiments, the water filter cartridge further comprises a filter key structured to cause a pair of opposing side locks of a spring lock mechanism of the appliance water filter manifold assembly to diverge from each other when the water filter cartridge is inserted into the appliance water filter manifold assembly.

In some embodiments or in combination with any of the previous embodiments, the water filter cartridge further comprises (i) a filter body comprising a filter medium, (ii) a water inlet port structured for receiving water from the appliance water filter manifold assembly, and (iii) a water outlet port structured for conveying filter water out of the water filter.

Embodiments of the invention are also directed to an appliance, which may be a refrigerator. The appliance (e.g., refrigerator) typically comprises an appliance water filter manifold assembly. The appliance (e.g., refrigerator) further comprises water filter cartridge, such as a water filter cartridge described by any of the embodiments, or any combination of embodiments, described herein. Typically, the water filter cartridge is structured to form a sealed connection with the appliance water filter manifold assembly. In some embodiments, the water filter cartridge comprises a connection assembly. The connection assembly comprises one or more connection devices structured for engaging an electrical connector of an appliance water filter manifold assembly of an appliance, to establish an electrical connection between the connection assembly and a controller of the appliance. Typically, the one or more connection devices are structured to be positioned in mechanical and electrical engagement with curved contact sections of substrate engagement sections of one or more contacts of the electrical connector, wherein the substrate engagement sections extend from compliant sections of the one or more contacts, wherein the compliant sections extend from termination sections of the one or more contacts, wherein the termination sections are connected to a surface of the electrical connector.

Embodiments of the invention are also directed to a method of insertion of a water filter cartridge at an appliance. Typically, the method begins with providing the water filter cartridge comprising a connection assembly having one or more connection devices. Next, the method involves, inserting the water filter cartridge into a receptacle of an appliance water filter manifold assembly of the appliance in a first direction. Moreover, the method involves, while inserting, engaging the one or more connection devices with one or more contacts of the appliance water filter manifold assembly such that the one or more connection devices (i) cause flexing of the one or more contacts from a first position to a second position and (ii) maintain engagement with the one or more contacts during the flexing of the one or more contacts from the first position to the second position. The method also involves partially retracting the water filter cartridge in a second direction opposite to the first direction such that the one or more contacts flex from the second position to a third position. Moreover, the method involves, while partially retracting, maintaining engagement between the one or more connection devices and the one or more contacts during the flexing of the one or more contacts from the second position to the third position. Typically, the one or more connection devices and the one or more contacts are in engagement following completion of the partial retraction of the water filter cartridge.

In some embodiments or in combination with any of the previous embodiments, each of the one or more connection devices comprises a connection surface structured such that the connection surface maintains an engagement with the one or more contacts during flexing of the one or more contacts.

In some embodiments or in combination with any of the previous embodiments, the method further comprises, while inserting, engaging a filter key of the water filter cartridge with a locking mechanism of the appliance water filter manifold assembly.

In some embodiments or in combination with any of the previous embodiments, the filter key of the water filter cartridge engages the locking mechanism of the appliance water filter manifold assembly such that the filter key causes a pair of opposing side locks of the spring lock mechanism to diverge from each other.

In some embodiments or in combination with any of the previous embodiments, upon completion of the partial retraction, the filter key of the water filter cartridge is in mechanical engagement with the locking mechanism of the appliance water filter manifold assembly.

In some embodiments or in combination with any of the previous embodiments, the method further comprises establishing an electrical communication link between a memory device of the connection assembly and the appliance water filter manifold assembly.

In some embodiments or in combination with any of the previous embodiments, the one or more connection devices engage with the one or more contacts such that one or more connection devices are positioned in mechanical and electrical engagement with curved contact sections of substrate engagement sections of the one or more contacts. Typically, the substrate engagement sections extend from compliant sections of the one or more contacts, the compliant sections extend from termination sections of the one or more contacts, and the termination sections are mounted on an electrical connector of the appliance water filter manifold assembly.

In some embodiments or in combination with any of the previous embodiments, the first position of the one or more contacts is the same as the third position of the one or more contacts.

Embodiments of the invention are also directed to a method of removal of a water filter cartridge from an appliance. Typically, the method begins with inserting the water filter cartridge at the appliance in accordance with any of the embodiments described previously, such that the one or more connection devices and the one or more contacts remain in engagement after inserting the water filter cartridge. Next, the method involves, partially displacing the water filter cartridge in the first direction such that the water filter cartridge is linearly displaced in the first direction. Moreover, the method involves, while partially displacing, applying, by the one or more connection devices, a force onto the one or more contacts of the appliance water filter manifold assembly in the first direction, wherein applying the force is structured to cause automatic partial displacement of the water filter cartridge in the second direction opposite to the first direction. Finally, the method involves withdrawing the water filter cartridge from the receptacle of the appliance water filter manifold assembly.

Embodiments of the invention are also directed to a method for authentication of a water filter cartridge at an appliance. Typically, the method begins with establishing an electrical communication link between a memory device of a water filter cartridge and an appliance water filter manifold assembly of the appliance. Next, the method involves, retrieving, via the electrical communication link, a unique identifier associated with the water filter cartridge from the memory device. Moreover, the method involves, determining whether the unique identifier is a valid unique identifier. The method further involves either (i) authenticating the water filter cartridge for use in the appliance based on at least determining that the unique identifier is a valid unique identifier, or (ii) not authenticating the water filter cartridge for use in the appliance based on at least determining that the unique identifier is not a valid unique identifier.

In some embodiments or in combination with any of the previous embodiments, the method further involves providing the water filter cartridge having a connection assembly comprising (i) one or more connection devices structured for establishing the electrical communication link and (ii) the memory device storing the unique identifier associated with the water filter cartridge. The method also involves inserting the water filter cartridge into a receptacle of the appliance water filter manifold assembly.

In some embodiments or in combination with any of the previous embodiments, the method further involves the steps of retrieving, via the electrical communication link, filter age data associated with the water filter cartridge stored at the memory device; and determining whether the filter age data is associated with an expiration of the water filter cartridge. Typically, authenticating the water filter cartridge for use in the appliance further comprises authenticating the water filter cartridge based on at least determining that the filter age data is not associated with the expiration of the water filter cartridge.

In some embodiments or in combination with any of the previous embodiments, the method further involves the steps of retrieving, via the electrical communication link, filter age data associated with the water filter cartridge stored at the memory device, determining whether the filter age data is associated with an expiration of the water filter cartridge; and in response to determining that the filter age data is associated with the expiration of the water filter cartridge, initiating presentation of a notification to a user associated with the appliance indicating expiration of the water filter and/or transmitting a notification to an appliance manufacturer of the appliance indicating expiration of the water filter cartridge.

In some embodiments or in combination with any of the previous embodiments, determining that the filter age data is associated with the expiration of the water filter cartridge comprises (i) determining that the water filter cartridge has expired, or (ii) determining that the water filter cartridge is set to expire within a subsequent time period.

In some embodiments or in combination with any of the previous embodiments, presenting the notification to the user comprises transmitting control signals to at least one user interface device of the appliance that are structured to cause the at least one user interface device to present an indication to the user, wherein the at least one user interface device comprises one or more of (i) a display device structured to display an indication comprising a text associated with the expiration of the water filter cartridge, (ii) a lighting device structured to display an indication comprising light of a frequency spectrum associated with the expiration of the water filter cartridge, and/or (iii) an speaker device structured to display an indication comprising an audio output associated with the expiration of the water filter cartridge.

In some embodiments or in combination with any of the previous embodiments, presenting the notification to the user further involves the steps of presenting a first notification at a first time; receiving a user input associated with temporarily suspending the notification for an intermission time; in response to receiving the user input, (i) stopping the presentation of the first notification, and (ii) activating a timer associated with the intermission time; and in response to determining, via the timer, that the intermission time has elapsed, presenting a second notification to the user at a second time.

In some embodiments or in combination with any of the previous embodiments, presenting the notification to the user comprises transmitting control signals to a mobile device associated with the user structured to cause the mobile device to present an indication to the user. Typically, the indication comprises one or more of (i) a text, (ii) a light of a frequency spectrum, and/or (iii) an audio output associated with the expiration of the water filter cartridge.

In some embodiments or in combination with any of the previous embodiments, for allowing use of the water filter cartridge based on authenticating the water filter cartridge for use in the appliance based on at least determining that the unique identifier is a valid unique identifier, the method further involves the steps of activating a timer associated with the water filter cartridge; determining a run-time of the water filter cartridge based in elapsed time of the timer; and storing, via the electrical communication link, the run-time at the memory device of the water filter cartridge.

In some embodiments or in combination with any of the previous embodiments, in response to not authenticating the water filter cartridge, the method further involves initiating presentation of a notification to a user associated with the appliance indicating expiration of the water filter cartridge and/or performing an action associated with the water filter cartridge.

Embodiments of the invention are also directed to a method of use of a water filter cartridge at an appliance. Typically, the method begins with providing the water filter cartridge comprising a water inlet port and a water outlet port. Next, the method involves, inserting the water filter cartridge into a receptacle of a water filter manifold assembly of the appliance. The water filter manifold assembly having an electrical connector comprising one or more contacts, wherein the one or more contacts comprise substrate engagement sections having curved contact sections, wherein the substrate engagement sections extend from compliant sections of the one or more contacts, wherein the compliant sections extend from termination sections of the one or more contacts, wherein the termination sections are connected to a surface of the electrical connector. Moreover, the method involves, receiving a notification associated with authentication of the water filter cartridge.

In some embodiments or in combination with any of the previous embodiments, the notification associated with the water filter cartridge comprises an indication associated with (i) successful authentication of the water filter cartridge, (ii) unsuccessful authentication of the water filter cartridge, and/or (iii) activation of the water filter cartridge for use at the appliance.

In some embodiments or in combination with any of the previous embodiments, the notification associated with the water filter cartridge comprises one or more of (i) a text, (ii) a light of a frequency spectrum, and/or (iii) an audio output associated with the expiration of the water filter cartridge.

In some embodiments or in combination with any of the previous embodiments, the notification is received via the appliance and/or a user device of associated with a user.

### BRIEF DESCRIPTION OF THE DRAWINGS

The features and functions of the invention, and the manner in which the same are accomplished, will become more readily apparent upon consideration of the following detailed description of the invention taken in conjunction with the accompanying drawings, which illustrate preferred and exemplary embodiments and which are not necessarily drawn to scale, wherein:

FIG. 1 depicts a top perspective view of an illustrative embodiment of an electrical connector and wire harness according to the present invention.

FIG. 2 depicts a bottom perspective view of the electrical connector and wire harness of FIG. 1.

FIG. 3 depicts an exploded perspective view of the electrical connector and wire harness of FIG. 1.

FIG. 4 depicts an enlarged view of several contacts of the electrical connector of FIG. 3.

FIG. 5 depicts a top perspective view of a second illustrative embodiment of an electrical connector and wire harness according to the present invention.

FIG. 6 depicts a bottom perspective view of the electrical connector and wire harness of FIG. 5.

FIG. 7 depicts an exploded perspective view of the electrical connector and wire harness of FIG. 5.

FIG. 8 depicts a perspective view of a filter cartridge, in accordance with some embodiments of the invention.

FIG. 9 depicts a perspective view of a manifold connector element, in accordance with some embodiments of the invention.

FIG. 10 depicts a block network architecture diagram illustrating a system environment for water filter authentication, in accordance with some embodiments of the invention.

FIG. 11 depicts a high level process flow for a method of insertion of a water filter cartridge at an appliance, in accordance with some embodiments of the invention.

FIG. 12 depicts a high level process flow for a method of authentication of a water filter cartridge at an appliance, in accordance with some embodiments of the invention.

FIG. 13 depicts a high level process flow for a method of use of a water filter cartridge at an appliance, in accordance with some embodiments of the invention.

### DETAILED DESCRIPTION OF THE INVENTION

The present invention now will be described more fully hereinafter with reference to the accompanying drawings, in which some, but not all embodiments of the invention are shown. This invention may be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

The description of illustrative embodiments according to principles of the present invention is intended to be read in connection with the accompanying drawings, which are to be considered part of the entire written description. In the description of embodiments of the invention disclosed herein, any reference to direction or orientation is merely intended for convenience of description and is not intended in any way to limit the scope of the present invention. Relative terms such as “lower,” “upper,” “horizontal,” “vertical,” “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation unless explicitly indicated as such. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise.

Moreover, the features and benefits of the invention are illustrated by reference to the preferred embodiments. Accordingly, the invention expressly should not be limited to such embodiments illustrating some possible non-limiting combination of features that may exist alone or in other combinations of features, the scope of the invention being defined by the claims appended hereto.

Various consumer appliances such as refrigerators utilize water filters to filter and/or purify water utilized by or dispensed by the appliance. These water filters typically take the form of replaceable water filters, which should to be replaced upon expiration of their effective usability, beyond which they become less effective in filtering water and reducing contaminants in the water. Conventional systems and water filters are not configured for determining whether a replacement water filter has expired or even whether the replacement water filter is compatible with the appliance it is being used in. Convention systems are also not able to identify whether an inserted water filter is authentic or whether it is a counterfeit. Counterfeit filters may not be as effective in filtering the water. Accordingly, it is desirable to identify counterfeit filters.

The present invention alleviates the above deficiencies and also provides additional new functions and advantages. Specifically, the present invention provides an improved water filter cartridge that is structured for authenticating the water filter, determining its usage and expiration, and tracking of the use of the water filter cartridge, dynamically and in real-time.

In addition, it may be desirable for a movable component to make an electrical connection with a base component. For example, it may be desirable to position a removable water filter (also referred to as a removable water filter cartridge) in electrical connection with the circuitry of an appliance, such as a refrigerator (e.g., in order for the refrigerator to allow water to flow to through the removable filter to properly filter the water). An electrical connector which interfaces with the movable component (e.g., water filter cartridge, or a connection assembly of the water filter cartridge) may be used to make an electrical connection with the electrical component of the movable component as the contacts of the electrical connector are compressed. Such connection may be achieved through the use of printed circuit boards and expensive contacts of the electrical connector. However, it would be beneficial to provide an electrical connector with movable components which does not require a printed circuit board and which does not require expensive contacts, while providing a reliable electrical connection.

As used herein, an “appliance” may refer to a device or equipment associated with input, output/dispensing, cooling, heating, filtering, purifying, distilling, and/or other processing of a fluid, such as water. In some embodiments, the appliance is associated with filtering the fluid such as water, for consumption by users. In some embodiments, the appliance is a domestic appliance, while in other embodiments, the appliance may be an industrial appliance. Non-limiting examples of an appliance include, a refrigerator, a freezer, a water purifier, an icemaker, etc. That said, in some embodiments, the appliance is a refrigerator.

Typically, the fluid is water and the appliance comprises a water filter for filtering (or otherwise purifying) the water. This water filter is in the form of a water filter cartridge, and specifically, a replaceable water filter cartridge. Typically, each water filter cartridge, and its filter media in particular, is structured to filter water by eliminating and/or reducing concentrations of contaminants in the water. Typically, each water filter cartridge loses filtration capacity and ability over time due to mechanical and chemical utilization of the internal filter media. Accordingly, each water filter cartridge has a working lifespan and a corresponding expiration timeframe/period, beyond which the water filter cartridge may not be able to effectively filter water. Upon expiration of the lifespan of the water filter cartridge in an appliance, the water filter cartridge may be replaced with another water filter cartridge in the appliance. Although referred to as a “water filter” or a “water filter cartridge”, it is understood that the filter or filter cartridge of the present invention may also be configured for filtering other fluids, colloids, suspensions, etc. It is noted that the terms “water filter” and “water filter cartridge” are used interchangeably herein.

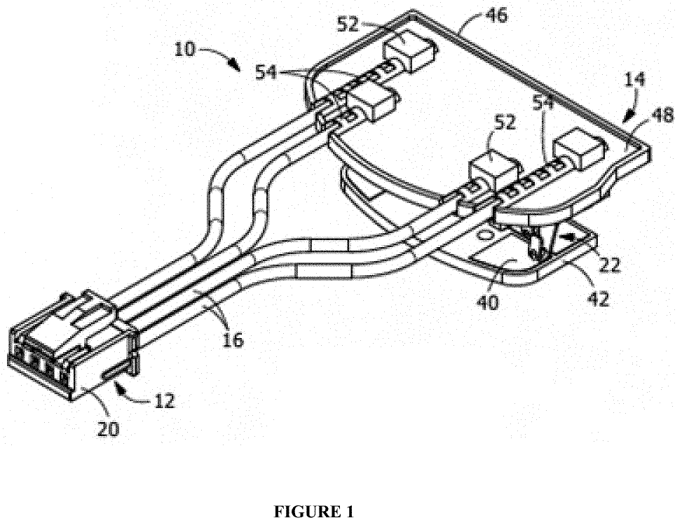

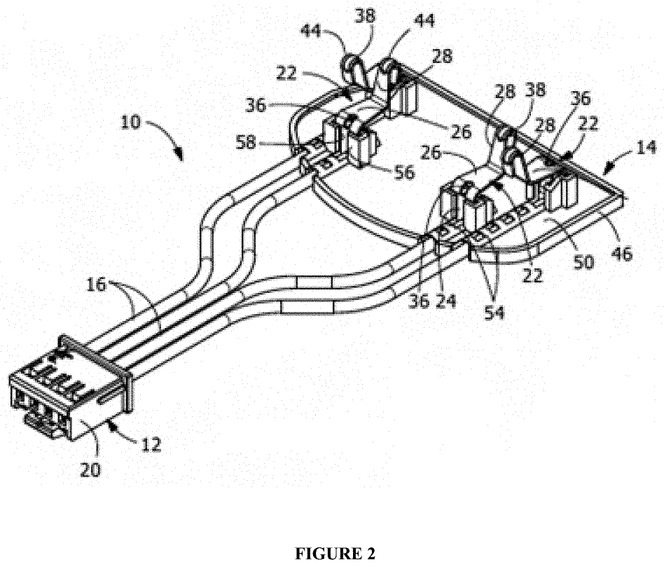

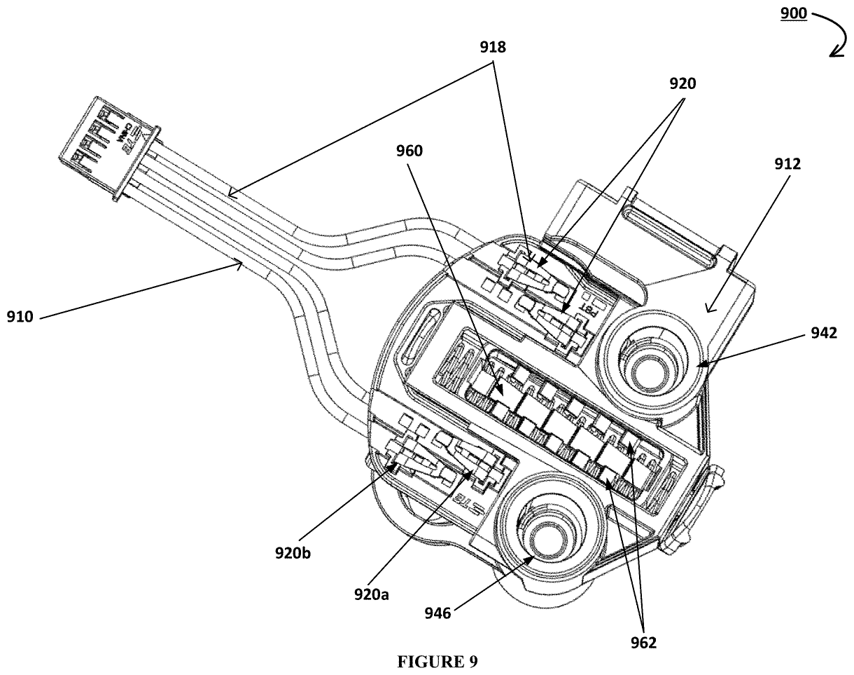

Referring to FIGS. 1 and 2, an illustrative wire harness 10 (also referred to as an electrical connector 10) includes a first connector 12, a second connector 14 and wires or conductors 16 extending therebetween. In the embodiment shown, four conductors 16 are provided, but other number of conductors 16 can be provided to accommodate the electrical requirements without departing from the scope of the invention. In typical applications, the harness 10 is operatively connected to, positioned at, and/or forms a part of an appliance water filter manifold assembly of an appliance (e.g., as described with respect to FIG. 9). Here, in some embodiments, the first connector 12 of the wire harness 10 is operatively coupled (e.g., electrically and mechanically coupled) with a corresponding connection component of the appliance water filter manifold assembly.

Contacts 18 are provided at one end of the conductors 16. The contacts 18 are configured to be inserted into the housing 20 of the first connector 12. While crimped contacts 18 are shown, the contacts 18 are not so limited. In addition, the first connector 12 is not limited to the type of plug connector shown. In some embodiments, the first connector 12 is connected to the circuitry of an appliance, such as a refrigerator.

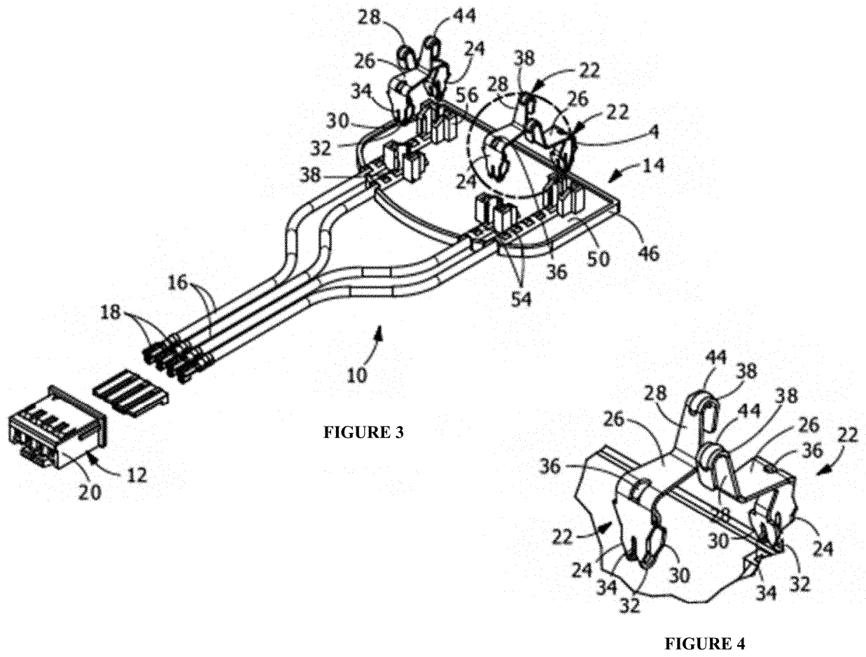

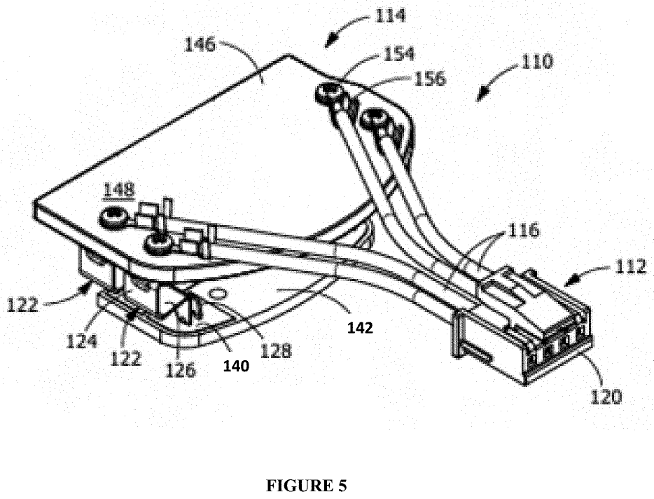

As best shown in FIGS. 2 through 4, the second connector 14 has contacts 22 provided therein. In the embodiment shown, four contacts 22 are provided so that each of the conductors 16 may be terminated. However, other numbers of contacts 22 may be provided based on the number of conductors 16. The contacts 22 are stamped and formed from material having the appropriate electrical and mechanical characteristics.

The contacts 22 have wire termination sections 24, transition or compliant sections 26 and substrate engagement sections 28. The wire termination sections 24 have folded over areas 30 provided proximate the free ends 32. Slots 34 are provided in the folded over areas 30 to form insulation displacement slots which cooperate with the conductors 16 to place the contacts 22 in electrical engagement with the conductors 16.

The transition or compliant sections 26 extend from the wire termination sections 24. In the illustrative embodiment shown, the transition or compliant sections 26 extend at essentially right angles from the wire termination sections 24, although other angles may be used. Embossments 36 extend from the wire termination sections 24 to the transition or compliant sections 26 to provide additional strength and stability between the wire termination sections 24 and the transition or compliant sections 26. The shape, size and positioning of the embossments 36 may be varied depending upon the amount of stiffness or resiliency of the contacts that is desired.

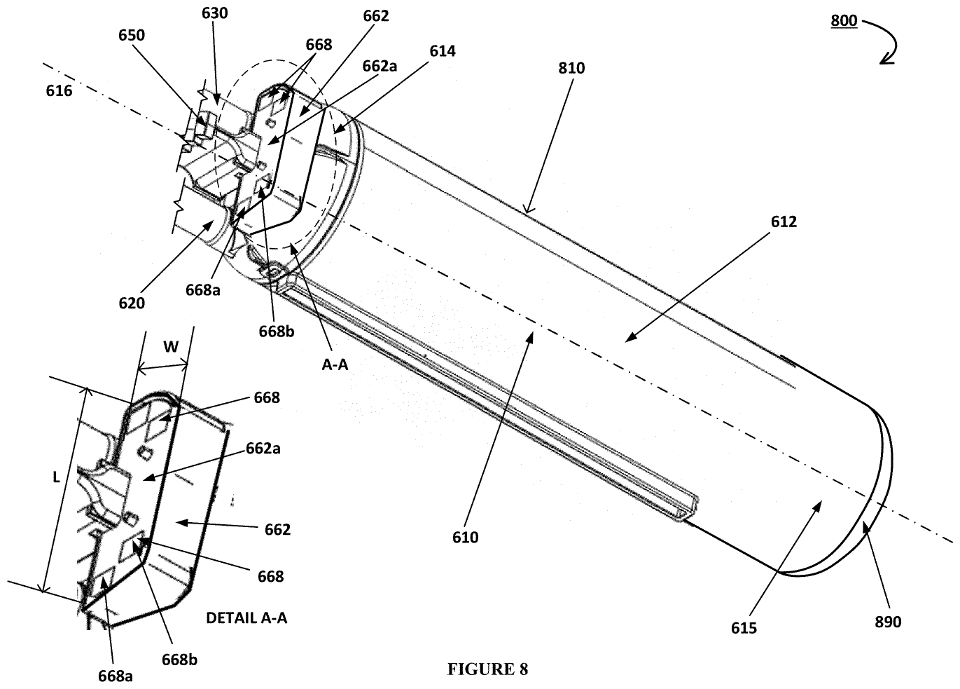

The substrate engagement sections 28 extend from the transition or compliant sections 26. In the illustrative embodiment shown, the substrate engagement sections 28 extend at essentially right angles from the transition or compliant sections 26, although other angles may be used. The substrate engagement sections 28 have curved contact sections 38 which are configured to be positioned in mechanical and electrical engagement with circuit pads 40 or connection devices 40 (e.g., of a corresponding connection assembly having an electronic circuit component 42 such as a printed circuit board). In some embodiments, the electronic circuit component 42 (e.g., a printed circuit board) is part of a connection assembly of a filter cartridge (e.g., a water filter cartridge), as will be described with respect to FIGS. 8-12 herein. In a particular embodiment, the wire harness 10 is positioned within an appliance water filter manifold assembly of an appliance. In some embodiments, the appliance is a refrigerator. Here, the wire harness 10 is positioned within a refrigerator manifold (i.e., the appliance water filter manifold assembly) that is configured to receive a filter cartridge (e.g., a water filter cartridge). In such embodiment, the wire harness 10 may be employed to establish an electrical connection between the circuitry of the refrigerator and the connection assembly of the filter cartridge (e.g., a water filter cartridge). Embossments 44 are provided on the curved contact sections 38 to provide additional strength and stability to the curved contact sections 38. The shape, size and positioning of the embossments 44 may be varied depending upon the amount of stiffness or resiliency of the contacts that is desired.

The housing 46 of the second connector 14 has an upper surface 48 and an oppositely facing lower surface 50. Contact-receiving enclosures 52 extend from the upper surface 48 in a direction away from the lower surface 50. In the embodiment shown, four contact-receiving enclosures 52 are provided so that each of the contacts 22 may be positioned in a contact-receiving enclosure 52. However, other numbers of contact-receiving enclosures 52 may be provided based on the number of contacts 22 and conductors 16. The contact-receiving enclosures 52 are dimensioned to receive the free ends 32 of the contacts 22 and a portion of the folded over areas 30 of the wire termination sections 24 therein.

Conductor-receiving conduits 54 are provided between the upper surface 48 and the lower surface 50. The conductor-receiving conduits 54 are dimensioned to receive a portion of the conductors 16 therein. The conductor-receiving conduits 54 are provided in-line with the contact-receiving enclosures 52 such that the conductors 16 positioned in the conductor-receiving conduits 54 extend through the contact-receiving enclosures 52.

Contact-receiving projections 56 extend from the lower surface 50 in a direction away from the upper surface 48. In the embodiment shown, four contact-receiving projections 56 are provided so that each of the contacts 22 may be positioned in a contact-receiving projection 56. However, other numbers of contact-receiving projections 56 may be provided based on the number of contacts 22 and conductors 16. Slots 58 are provided in the contact-receiving projections 56. The slots 58 are dimensioned to receive and retain a portion of the folded over areas 30 of the wire termination sections 24 therein.

During assembly of the second electrical connector 14 and the wire harness 10, the conductors 16 are inserted in the conductor-receiving conduits 54, such that ends of the conductors 16 extend in the conductor-receiving conduits 54 past the contact-receiving enclosures 52.

With the conductors 16 fully inserted, the contacts 22 are inserted into the housing 46 from the bottom surface 50. The folded over areas 30 of the wire termination sections 24 are inserted into the slots 58 of the contact-receiving projections 56. As the insertion of the contacts 22 continues, the slots 34 of the folded over areas 30 of the wire termination sections 24 engage the conductors 16 positioned in the conductor-receiving conduits 54, causing the insulation of the conductors 16 to be displaced, as is known for insulation displacement type contacts, and providing a mechanical and electrical connection between the contacts 22 and the conductors 16.

With the wire termination sections 24 properly positioned in the slots 58 of the contact-receiving projections 56, the wire termination sections 24 are maintained in position by barbs, interference fit, or other know means.

With the contacts 22 properly secured to the conductors 16 and the housing 46 of the electrical connector 14, the electronic circuit component 42, such as a printed circuit board, is moved into engagement with the curved sections 38 of the substrate engagement sections 28 of the contacts 22. As this occurs, the contacts 22 being resilient, flex (e.g., compress or deform) from one position to another, such that the curved sections 38 of the substrate engagement sections 28 of the contacts 22 exert a force on the circuit pads 40 (also referred to as one or more connection devices 40) of the electronic circuit component 42 (e.g., a printed circuit board) to retain the contacts 22 in mechanical and electrical engagement with the circuit pads 40.

When mating between the printed circuit board 42 and the contacts 22 occurs, the movement of the electronic circuit component 42 (e.g., a printed circuit board) toward the electrical connector 14 causes the contacts 22 to resilient deform or deflect by 4 mm or more to provide a sufficient mating force between the contacts 22 and the circuit pads 40. As the resilient deflection of the contacts 22 occur, the wire termination sections 24 remains in a fixed position in the slots 58 of the contact-receiving projections 56. The substrate engagement sections 28 are moved in a direction which is essentially parallel to the longitudinal axis of the contacts 22, causing the transition or compliant sections 26 to pivot about the points where the transition or compliant sections 26 engage the wire termination sections 24. The rigidity of the points where the transition or compliant sections 26 engage the wire termination sections 24 and the rigidity of the embossments 36 determine the mating force applied by the contacts 22 to the circuit pads 40.

After mating of the circuit pads 40 to the contacts 22 occurs, the electrical connector 14 and the electronic circuit component 42 (e.g., a printed circuit board) are maintained in position by latches or other means to prevent the unwanted withdraw of the circuit pads 40 from the contacts 22.

Referring to FIGS. 5 through 7, a second illustrative wire harness 110 (also referred to as an electrical connector 110) includes a first connector 112, a second connector 114 and wires or conductors 116 extending therebetween. In the embodiment shown, four conductors 116 are provided, but other number of conductors 116 can be provided to accommodate the electrical requirements without departing from the scope of the invention.

Contacts 118 are provided at one end of the conductors 116. The contacts 118 are configured to be inserted into the housing 120 of the first connector 112. While crimped contacts 118 are shown, the contacts 118 are not so limited. In addition, the first connector 112 is not limited to the type of plug connector shown. In some embodiments, the first connector 112 is connected to the circuitry of an appliance (e.g., a refrigerator).

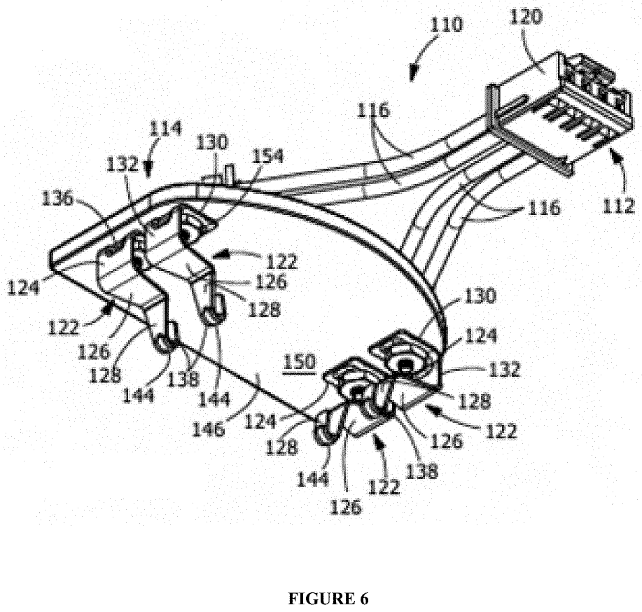

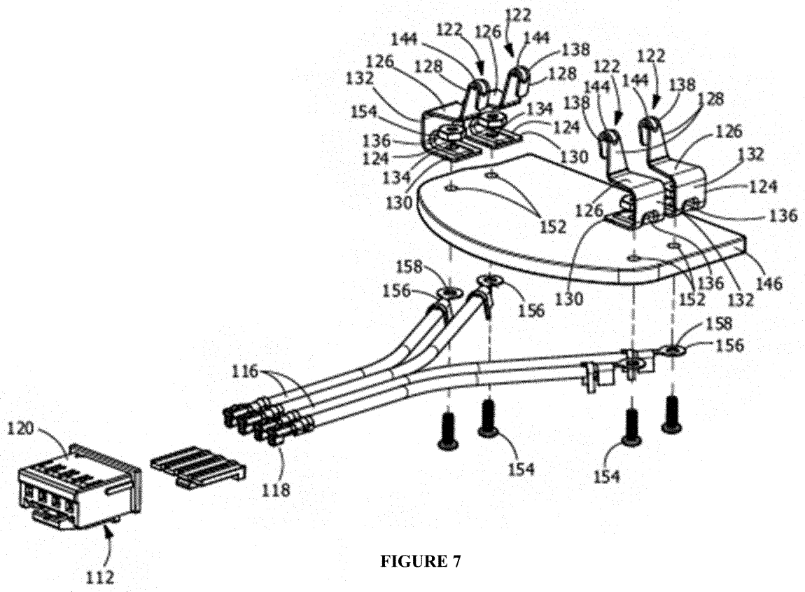

As best shown in FIGS. 6 and 7, the second connector 114 has contacts 122 provided therein. In the embodiment shown, four contacts 122 are provided so that each of the conductors 116 may be terminated. However, other numbers of contacts 122 may be provided based on the number of conductors 116. The contacts 122 are stamped and formed from material having the appropriate electrical and mechanical characteristics.

The contacts 122 have housing termination sections 124, transition or compliant sections 126 and substrate engagement sections 128. The housing termination sections 124 have housing engagement members 130 which extend from vertical members 132. Mounting openings 134 (FIG. 7) are provided in the housing engagement members 130. In the illustrative embodiment shown, the housing engagement members 130 extend at essentially right angles from the vertical members 132, although other angles may be used. Embossments 136 extend from the housing engagement members 130 to the vertical members 132 to provide additional strength and stability. The shape, size and positioning of the embossments 136 may be varied depending upon the amount of stiffness or resiliency of the contacts that is desired.

The transition or compliant sections 126 extend from the housing termination sections 124. In the illustrative embodiment shown, the transition or compliant sections 126 extend at essentially right angles from the housing termination sections 124, although other angles may be used.

The substrate engagement sections 128 extend from the transition or compliant sections 126. In the illustrative embodiment shown, the substrate engagement sections 128 extend at essentially right angles from the transition or compliant sections 126, although other angles may be used. The substrate engagement sections 128 have curved contact sections 138 which are configured to be positioned in mechanical and electrical engagement with circuit pads 140 of a mating printed circuit board 142 (FIG. 5). Embossments 144 are provided on the curved contact sections 138 to provide additional strength and stability between the curved contact sections 138. The shape, size and positioning of the embossments 144 may be varied depending upon the amount of stiffness or resiliency of the contacts that is desired.

The housing 146 of the second connector 114 has an upper surface 148 and an oppositely facing lower surface 150. As best shown in FIG. 7, openings 152 extend from the upper surface 148 to the lower surface 150. In the embodiment shown, four openings 152 are provided, however other numbers of openings 152 may be provided based on the number of contacts 122 and conductors 116. The openings 152 are dimensioned to receive the mounting hardware 154 therein.

Ring contacts 156 are provided at the ends of the conductors 116. The ring contacts 156 are provided in-line with the openings 152. The ring contacts 156 have openings 158 to receive the mounting hardware 154 therein.

During assembly of the second electrical connector 114 and the wire harness 110, the openings 158 of the ring contacts 156 of the conductors 116 are positioned in line with the openings 152. The mounting openings 134 of the contacts 122 are also positioned in line with the openings 152. The mounting hardware 154 is inserted through the openings 158, the openings 152 and the openings 134 to secure the conductors 116 and the contacts 122 to the housing 146. The mounting hardware 146 also provides the electrical connection between the ring contacts 156 of the conductors 116 and the contacts 122.

With the contacts 122 properly secured to the housing 146 of the electrical connector 114, the printed circuit board 142 is moved into engagement with the curved sections 138 of the substrate engagement sections 128 of the contacts 122. As this occurs, the contacts 122 being resilient, flex (e.g., compress or deform) from one position to another, such that the curved sections 138 of the substrate engagement sections 128 of the contacts 122 exert a force on the circuit pads 140 of the printed circuit board 142 to retain the contacts 122 in mechanical and electrical engagement with the circuit pads 140.

When mating between the printed circuit board 142 and the contacts 122 occurs, the movement of the printed circuit board 142 toward the electrical connector 114 causes the contacts 122 to resilient deform or deflect by 4 mm or more to provide a sufficient mating force between the contacts 122 and the circuit pads 140. As the resilient deflection of the contacts 122 occur, the housing engagement members 130 and the vertical members 132 of the housing termination sections 124 remains in a fixed position. The substrate engagement sections 128 are moved in a direction which is essentially parallel to the longitudinal axis of the contacts 122, causing the transition or compliant sections 126 to pivot about the points where the transition or compliant sections 126 engage the vertical members 132. The rigidity of the points where the transition or compliant sections 26 engage the vertical members 132 determine the mating force applied by the contacts 122 to the circuit pads 140.

After mating of the circuit pads 140 to the contacts 122 occurs, the electrical connector 114 and the circuit board 142 are maintained in position by latches or other means to prevent the unwanted withdraw of the circuit pads 140 from the contacts 122.

In a particular embodiment, an appliance (e.g., a refrigerator) may include the wire harness 110, and the wire harness 110 may be connected to the circuitry of the appliance. In the instances where the appliance is a refrigerator, the wire harness 110 may part of a refrigerator manifold that is configured to receive a water filter. In this regard, the printed circuit board 142 may be located on the exterior of the water filter and connected to the circuitry of the water filter. When the water filter is inserted into the manifold, the wire harness 110 engages the printed circuit board 142 in order to establish an electrical connection between the circuitry of the refrigerator and the circuitry of the water filter.

FIG. 8 illustrates a perspective view 800 of a water filter cartridge 810, in accordance with some embodiments of the invention. The water filter cartridge 810 is also referred to as a filter housing assembly. As illustrated by FIG. 8, the water filter cartridge 810 comprises a housing 610, first portion 614 (e.g., a top portion) and an opposite second portion 615 (e.g., a bottom portion). The housing comprises a filter body 612 such as an elongate or substantially cylindrical body. The first portion 614 is structured for forming a fluid-tight seal with the body. The first portion 614 is depicted as a convex, substantially dome-shaped to facilitate the filter housing assembly as a pressurized vessel. However, it may be a flat surface or a concave surface, depending on the application. The filter body 612 and housing first portion 614 share a longitudinal axial center line 616. The filter body 612 may hold a filter media therein for the filtration of fluids such as water, may act as a sump, or may act as a bypass filter cartridge having no filtration media. The water filter cartridge 810 is structured to form a sealed connection with an appliance water filter manifold assembly of an appliance (such as a refrigerator), e.g., for the purposes of filtering fluids therethrough.

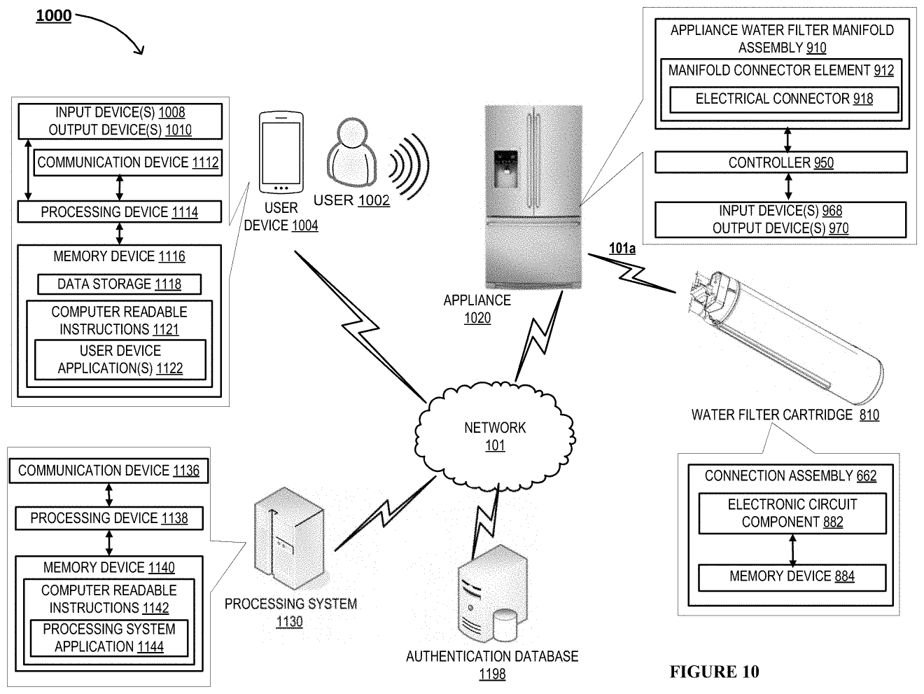

Moreover, the water filter cartridge 810 comprises an inlet port 620 (e.g., a water inlet port). FIG. 8 illustrates a cutaway view of the inlet port 620. The inlet port 620 (also referred to as an ingress port 620) is structured for receiving water (e.g., water or another fluid to be filtered) from the appliance water filter manifold assembly 910 of an appliance 1020 (illustrated in FIGS. 9-10). The water filter cartridge 810 further comprises an outlet port 630 (e.g., a water outlet port). FIG. 8 illustrates a cutaway view of the outlet port 630. The outlet port 630 (also referred to as an egress port 630) is structured for convening water (e.g., filtered fluid or filtered water) from the water filter cartridge 810 to the appliance water filter manifold assembly. The inlet/ingress port 620 comprises an inlet aperture for receiving water into the water filter cartridge 810, while the outlet/egress port 630 comprises an outlet aperture for dispensing water out of the water filter cartridge 810.

As illustrated by FIG. 8, the inlet/ingress port 620 comprises a substantially elongate, generally cylindrical shape, extending/protruding in a longitudinally axial direction from the surface of housing first portion 614 substantially parallel to the axial center line 616. The inlet/ingress port 620 is structured such that a fluid seal is maintained between the appliance water filter manifold assembly and the inlet/ingress port 620, thereby preventing water from leaking during transfer. In this regard, the inlet/ingress port 620 typically comprises one or more seals (e.g., circumferential seals) that provide a circumferential press-fit or sealing force against corresponding receptacle portions (e.g., inlet port 942 illustrated in FIG. 9) of the appliance water filter manifold assembly. The one or more seals are typically held in place on the inlet/ingress port 620 typically by insertion into a groove within the inlet/ingress port 620's outer surface 662a, such that a diameter of the outermost seal radial extension is slightly greater than the inner wall diameter of the receptacle portions (e.g., inlet port 942 illustrated in FIG. 9) of the appliance water filter manifold assembly, allowing the resilient, compressible seals to be compressed by the inner wall of the receptacle portions (e.g., inlet port 942 illustrated in FIG. 9) of the appliance water filter manifold assembly upon insertion.

Similarly, as illustrated by FIG. 8, the outlet/egress port 630 comprises a substantially elongate, generally cylindrical shape, extending/protruding in a longitudinally axial direction from the surface of housing first portion 614 substantially parallel to the axial center line 616 and parallel to the inlet/ingress port 620. The outlet/egress port 630 is structured such that a fluid seal is maintained between the appliance water filter manifold assembly and the outlet/egress port 630, thereby preventing water from leaking during transfer. In this regard, the outlet/egress port 630 typically comprises one or more seals (e.g., circumferential seals) that provide a circumferential press-fit or sealing force against corresponding receptacle portions (e.g., outlet port 946 illustrated in FIG. 9) of the appliance water filter manifold assembly. The one or more seals are typically held in place on the outlet/egress port 630 typically by insertion into a groove within the outlet/egress port 630's outer surface, such that a diameter of the outermost seal radial extension is slightly greater than the inner wall diameter of the receptacle portions (e.g., outlet port 946 illustrated in FIG. 9) of the appliance water filter manifold assembly, allowing the resilient, compressible seals to be compressed by the inner wall of the receptacle portions (e.g., outlet port 946 illustrated in FIG. 9) of the appliance water filter manifold assembly upon insertion.

In some embodiments, the inlet/ingress port 620 may be substantially similar to any of the inlet/ingress ports described in U.S. Patent Application Publication No. 2019/0134543A1, entitled “Push filter with floating key lock,” which is hereby incorporated by reference in its entirety. Similarly, in some embodiments, the outlet/egress port 630 may be substantially similar to any of the outlet/egress ports 630 described in U.S. Patent Application Publication No. 2019/0134543A1.

The water filter cartridge 810 further comprises a filter key 650 that is structured for establishing operative mechanical engagement with and mating attachment to the appliance water filter manifold assembly. FIG. 8 illustrates a cutaway view of the filter key 650. The filter key 650 may comprise any suitable mechanism for securing or engaging the water filter cartridge 810 at a corresponding compatible portion of the appliance water filter manifold assembly.

In some embodiments, as a non-limiting example, the filter key 650 extends upwards in a direction parallel to the axial center 616 of the housing first portion 614. The filter key 650 is secured to the housing first portion 614 via a coupling element. The filter key 650 comprises a substantially “I” shaped cross-section. The filter key 650 key is structured to cause a pair of opposing side locks 962 of a lock mechanism 960 of the appliance water filter manifold assembly (illustrated in FIG. 9) to diverge from each other when the water filter cartridge is inserted into the appliance water filter manifold assembly and subsequently flex back and clamp down on the filter key 650, thereby removably securing the water filter cartridge 810 with the appliance water filter manifold assembly. That said, any other suitable configuration of the filter key 650 may be utilized.

In some embodiments, the filter key 650 may be substantially similar to any of the filter keys described in U.S. Patent Application Publication No. 2019/0134543A1.

As illustrated by FIG. 8, the water filter cartridge 810 comprises a connection assembly 662. The connection assembly 662 is structured for establishing electronic engagement/ electrical connection between the water filter cartridge 810 and a controller of the appliance, via the appliance water filter manifold assembly. The connection assembly 662 comprises a connection body having a recess enclosing a memory device. The connection assembly 662 further comprises one or more connection devices 668 positioned at an outer surface 662a of the connection assembly 662, as illustrated by FIG. 8. In other words, the one or more connection devices 668 are positioned at an outer surface 662a while the memory device is positioned proximate an inner surface of the connection assembly 662.

The one or more connection devices 668 are structured for engaging an electrical connector 918 (illustrated in FIG. 9) of an appliance water filter manifold assembly of an appliance, to establish an electrical connection between the connection assembly 662 and a controller of the appliance. The one or more connection devices 668 may be substantially similar to the circuit pads 40 and 140 described previously. The electrical connector 918 is substantially similar to the wire harness (10, 110) described previously. Moreover, the electrical connector 918 (10, 110) comprises one or more contacts 920 that may be substantially similar to contacts (22, 122) with curved contact sections (38, 138) described previously.

The one or more connection devices 668 are positioned at a first surface 662a, e.g., an outer surface 662a of the connection assembly 662, such that the one or more connection devices 668 are positioned in mechanical and electrical engagement with curved contact sections (38, 138) of substrate engagement sections (28, 128) of one or more contacts 920 (22, 122) of the electrical connector 918 (10, 110), respectively.

As discussed previously, when the connection assembly 662 is moved into engagement with the curved sections (38, 138) of the contacts 920 (22, 122) it causes the contacts (22, 122) to flex (e.g., deflect, compress, etc.) from a first position (e.g., a resting position) to a second position (e.g., a compressed position). Each of the one or more connection devices 668 comprises a connection surface. This connection surface is structured, shaped and dimensioned such that the connection surface, and in turn the connection device 668, maintains an engagement with the one or more contacts (22, 122) during flexing of the one or more contacts 920 (22, 122) from the first position to the second position. As such the connection devices 668, and in turn the connection surfaces, are dimensioned such that (i) engagement is maintained during flexing of the one or more contacts 920 (22, 122), (ii) while allowing for positioning of four or more connection devices 668 on the outer surface 662a. The outer surface 662a (e.g., a top surface of the connection assembly 662) may have a length L in the range of about 30 mm to 40 mm or 37 mm to 40 mm, and a width W in the range of about 14 mm to 18 mm or 14 mm to 16 mm. In this regard, connection devices 668 may comprise a length (measured parallel to the width W of the outer surface 662a) in the range of about 6.75 mm to 7.9 mm, 5 mm to 9 mm, 5.5 mm to 8 mm, 6.5 mm to 7.5 mm, 6.5 mm to 7 mm, and/or in between or overlapping these ranges. In this regard, connection devices 668 may comprise a width (measured parallel to the length L of the outer surface 662a) in the range of about 3.5 mm to 4.7 mm, 3 mm to 5 mm, 2 mm to 6 mm, 3.8 mm to 4.2 mm, 3.9 mm to 4 mm, and/or in between or overlapping these ranges.

As illustrated by FIG. 8, the one or more connection devices 668 comprise (i) a first connection device 668a which structured to engage a first contact (920a, illustrated in FIG. 9) of the one or more contacts 920 and (ii) an adjacent second connection device 668b structured to engage a second contact 920b of the one or more contacts 920, when the water filter cartridge 810 is inserted into the appliance water filter manifold assembly 910. As discussed, the engagement of the first and second connection devices (668a, 668b) with the respective the first and second contacts (920a, 920b) causes the flexure of the first contact and the second contact (920a, 920b). However, the first contact (920a) may flex such that it contacts or engages the second connection device 668b and may cause an undesirable electrical short circuit. To preclude this, the spatial distance between the first and second connection devices (668a, 668b), as well as the dimensions of the first and second connection devices (668a, 668b) themselves are structured such that flexure of the first and second contacts (920a, 920b) does not cause an electrical short circuit (while still allowing for positioning of four or more connection devices 668 on the outer surface 662a). In some embodiments, the spatial distance between proximate sides of the first and second connection devices (668a, 668b) may be in the range of about 0.5 mm to 1 mm, 0.2 mm to 1.5 mm, 0.5 mm to 0.8 mm, 0.5 mm to 1.1 mm, 0.2 mm to 4 mm, and/or in between or overlapping these ranges.

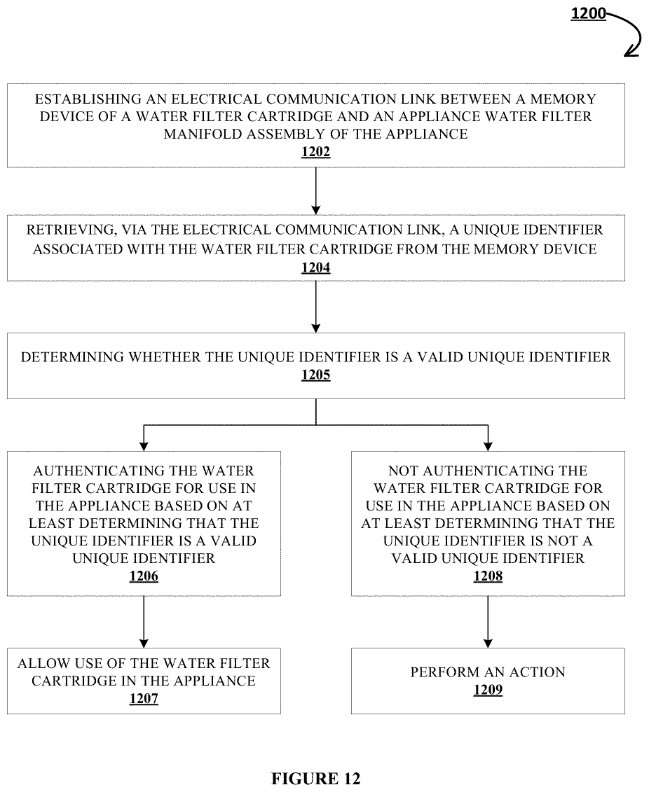

As noted, the connection assembly 662 further comprises a memory device structured to store a unique identifier associated with the water filter cartridge 810. This unique identifier is utilized for authenticating the water filter cartridge, as will be described with respect to FIG. 12. As discussed above, the memory device is positioned proximate a second, interior surface that is opposite the first surface 662a, and may be at least partially enclosed by the recess body connection assembly 662 such to seal the memory device from any water leakage. The memory device may be a microchip, an integrated circuit, or any other device capable of storing the unique identifier.

Furthermore, the connection assembly 662 comprises an electronic circuit component that electrically connects the one or more connection devices 668 and the memory device. In some embodiments, the electronic circuit component is a printed circuit board (PCB). In other embodiments, the electronic circuit component comprises a point-to-point connection, a wire wrap, etc.

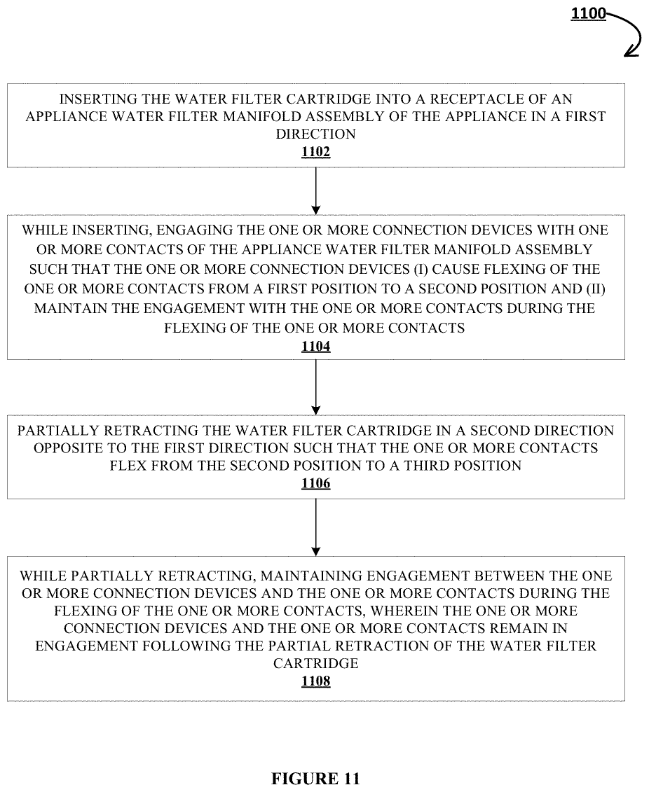

The second portion 615 is structured for facilitating insertion of the water filter cartridge into an appliance water filter manifold and removal of the water filter cartridge from an appliance water filter manifold. In this regard, the water filter cartridge 810 further comprises an end cap component 890 at the second portion 615 structured to facilitate the insertion mechanism and the withdrawal mechanism described with respect to FIG. 11.

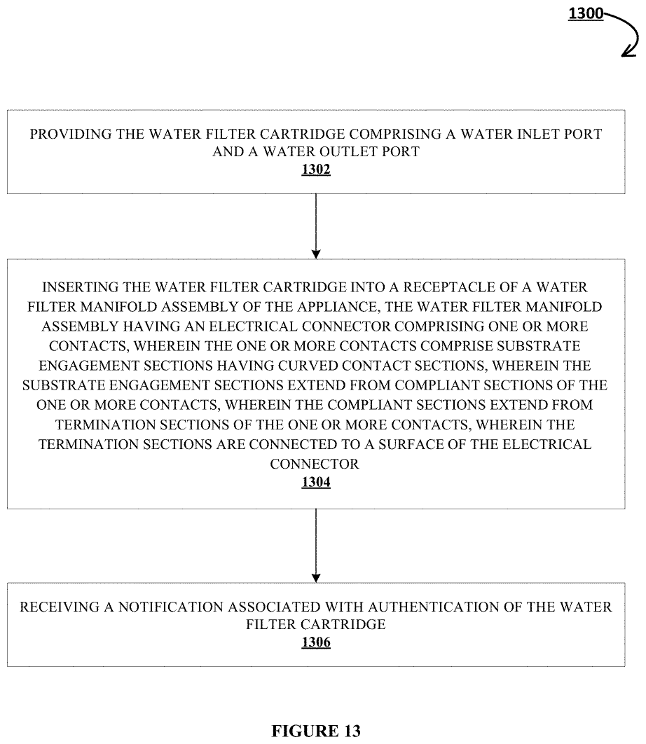

In some embodiments, the water filter cartridge 810 may be substantially similar to any of the water filter cartridges described in concurrently filed U.S. Non-Provisional Patent Application entitled “Push Filter with Floating Key Lock” (e.g., the filter housing assembly described with respect to FIGS. 12A-13C), which is hereby incorporated by reference in its entirety.

FIG. 9 illustrates a perspective view 900 of a manifold connector element 912 of an appliance water filter manifold assembly 910 of an appliance 1020 (illustrated in FIG. 10), in accordance with some embodiments of the invention. Typically, the appliance 1020 (e.g., a refrigerator) comprises an appliance water filter manifold assembly 910 that is structured for receiving water (or another fluid), filtering the water and dispensing filtered water, e.g., for use by other components of the appliance (e.g., icemaker), for dispensing to a user, etc. In this regard, the appliance water filter manifold assembly 910 comprises a receptacle structured for receiving the water filter cartridge 810. Typically, the receptacle is structured to enclose the water filter cartridge 810, except for at least a portion of the second portion 615 (e.g., a planar face of the end cap component 890) of the water filter cartridge 810. In some embodiments, the planar face of the end cap component 890 is exposed and is configured to be positioned flush with an outer surface of the appliance water filter manifold assembly 910. This exposed or not enclosed portion of the water filter cartridge 810 is utilized for insertion and removal of the water filter cartridge 810 from the receptacle. The manifold connector element 912 is positioned at one end of the receptacle (e.g., the end opposite the outer surface of the appliance water filter manifold assembly 910).

The manifold connection element 912 comprises an inlet port 942 structured for receiving the inlet/ingress port 620 of the water filter cartridge 810, and an outlet port 946 structured for receiving the outlet/egress port 630 of the water filter cartridge 810, when the water filter cartridge 810 is inserted into the receptacle of the appliance water filter manifold assembly 910. Moreover, the inlet port 942 is structured for supplying water to the inlet/ingress port 620 of the water filter cartridge 810, and the outlet port 946 is structured for receiving filtered water from the outlet/egress port 630 of the water filter cartridge 810. The appliance water filter manifold assembly 910 is configured such that the water filter cartridge 810 forms a sealed connection with the appliance water filter manifold assembly, when assembled therewith. In some instances, the sealed connection ensures that the water being supplied to the filter cartridge 810 and being transmitted out of the water filter cartridge does not leak out of the ports (942, 946), does not leak out of the appliance water filter manifold assembly 910 and/or does not drip within the appliance water filter manifold assembly 910.

The manifold connection element 912 further comprises an electrical connector 918 that is substantially similar to the wire harness (10, 110) described previously. Moreover, the electrical connector 918 (10, 110) comprises one or more contacts 920 that are substantially similar to contacts (22, 122) with curved contact sections (38, 138) described previously. As discussed previously, the electrical connector 918 is structured to establish an electrical connection between the connection assembly 662 and a controller of the appliance 1020, via the manifold connection element 912. As discussed previously with respect to FIG. 8, the one or more contacts 920 comprise a first contact 920a structured to engage a first connection device 668a of the water filter cartridge 810, and an adjacent second contact 920b structured to engage a second connection device 668b of the water filter cartridge 810.

The manifold connection element 912 further comprises a lock mechanism 960 (also referred to as a locking mechanism 960). The lock mechanism 960 is typically compatible for coupling with the filter key 650 of the water filter cartridge 810 when assembled together. As such the lock mechanism 960 may comprise any suitable structure that is compatible for coupling with the filter key 650.

As a non-limiting example, in some embodiments, the lock mechanism 960 may comprise a cavity having a plurality of opposing side locks extending into the cavity. As discussed previously, the filter key 650 key is structured to cause a pair of opposing side locks 962 of a lock mechanism 960 of the appliance water filter manifold assembly (illustrated in FIG. 9) to diverge from each other when the water filter cartridge 810 is inserted into the appliance water filter manifold assembly 910, and subsequently deflect back in the reverse direction and clamp down on the filter key 650, thereby removably securing the water filter cartridge 810 with the appliance water filter manifold assembly. In this regard, the lock mechanism 960 may be a spring-lock mechanism. That said, any other suitable configuration of the lock mechanism 960 may be utilized.

In some embodiments, the lock mechanism 960 may be compatible with any of the filter keys described in U.S. Patent Application Publication No. 2019/0134543A1. Moreover, in some embodiments, the lock mechanism 960 may be substantially similar to any of the protruding encasements and/or center apertures described in U.S. Patent Application Publication No. 2019/0134543A1.

Referring to FIG. 10, a block network architecture diagram illustrating a system environment 1000 for water filter authentication, is illustrated, in accordance with some embodiments of the invention. As illustrated, the system environment 1000 may comprise an appliance 1020, in operative communication with one or more user devices 1004 associated with a user 1002, a processing system 1130, an authentication database 1198, a water filter cartridge 810, and/or other systems/devices not illustrated herein, via a network 101. As such, the appliance 1020 is configured such that the user 1002 may perform one or more user activities by physically interacting with the appliance 1020 and/or by communicating via the network 101 using the user device 1004. Moreover, the water filter cartridge 810 may be mechanically and electrically coupled with the appliance 1020, as indicated by element 101a.

In some embodiments, the processing system 1130 (and/or and the authentication database 1198) is in electronic communication with the appliance 1020, via the network 101, which may be the internet, an intranet or the like. In other embodiments, the system environment 1000 does not include the processing system 1130. In FIG. 1, the network 101 may include a local area network (LAN), a wide area network (WAN), a global area network (GAN), and/or near field communication (NFC) network. The network 101 may provide for wireline, wireless, or a combination of wireline and wireless communication between devices in the network. In some embodiments, the network 101 includes the Internet. In some embodiments, the network 101 may include a wireless telephone network. Furthermore, the network 101 may comprise wireless communication networks to establish wireless communication channels such as a contactless communication channel and a near field communication (NFC) channel (for example, in the instances where communication channels are established between the user device 1004 and the appliance 1020). In this regard, the wireless communication channel may further comprise near field communication (NFC), communication via radio waves, communication through the internet, communication via electromagnetic waves and the like.

In some embodiments, the appliance 1020 communicates with, transmits signals to, and/or receives instructions from the processing system 1130, via the network 101, typically, in real-time. In some embodiments, the appliance 1020 communicates with the authentication database 1198 through the processing system 1130, typically, in real-time.

As such, the processing system 1130 is in operative communication with the appliance 1020. In some embodiments, processing system 1130 is configured to transmit control instructions that are configured to cause the appliance 1020 to perform at least a portion of the steps associated with authentication of the water filter cartridge 810 (e.g., those described with respect to FIG. 12). The processing system 1130 may be associated with the same entity as the appliance 1020 or may be associated with another entity. In some embodiments, the processing system 1130 may be owned by, operated by or be otherwise associated with a manufacturer of the appliance 1020, while in other embodiments, the processing system 1130 may be owned by, operated by or be otherwise associated with another entity (e.g., a third-party entity). The authentication database 1198 may comprise a database of stored unique identifiers associated with water filter cartridges, which are utilized by the processing system 1130 and/or appliance 1020 to validate retrieved identifiers from a memory device 884 of the water filter cartridge. The processing system 1130 and/or appliance 1020 may communicate with the authentication database 1198 via the network 101. Alternatively, the authentication database 1198 may be stored within the appliance 1020 and/or processing system 1130.

The user device 1004 may comprise a mobile communication device, such as a cellular telecommunications device (e.g., a smart phone or mobile phone), a computing device such as a laptop computer, a personal digital assistant (PDA), a mobile internet accessing device, a wearable device, or other mobile device including, but not limited to portable digital assistants (PDAs), pagers, mobile televisions, gaming devices, laptop computers, cameras, video recorders, audio/video player, radio, GPS devices, any combination of the aforementioned, or the like. As discussed previously, in some embodiments, the processing system 1130 and/or the appliance 1020 of the present invention are configured to establish operative communication channels with the user device 1004, e.g., for presenting one or more notifications to the user via the user device 1004.

The user device 1004 may generally include a processing device or processor 1114 communicably coupled to devices such as, a memory device 1116, user output devices 1010 (for example, a user display device, or a speaker), user input devices 1008 (such as a microphone, keypad, touchpad, touch screen, and the like), a communication device or network interface device 1112, and the like. The processor 1114 may include functionality to operate one or more software programs or applications, which may be stored in the memory device 1116. For example, the processor 1114 may be capable of operating applications the user device application 1122 which may be provided by the entity associated with the processing system 1130. The user device application 1122 may then allow the user device 1004 to receive notifications, suspend notifications, etc. The memory device 1116 and/or the data storage 1118 may comprise computer readable instructions 1121 associated with the user device application 1122, which may be executed by the processor 1114.

The processor 1114 may be configured to use the network interface device 1112 to communicate with one or more other devices on a network 101 such as, but not limited to the appliance 1020 and the processing system 1130. The network interface device 1112 or communication device 1112 may also include a user activity interface presented in user output devices 1010 in order to allow a user 1002 to execute some or all of processes described herein, e.g., view notifications, suspend notifications, etc. As used herein, memory may include any computer readable medium configured to store data, code, or other information. The memory device 1116 may include volatile memory, such as volatile Random Access Memory (RAM) including a cache area for the temporary storage of data. The memory device 1116 may also include non-volatile memory, which can be embedded and/or may be removable. The non-volatile memory may additionally or alternatively include an electrically erasable programmable read-only memory (EEPROM), flash memory or the like.

Typically, the appliance 1020 (e.g., a refrigerator) comprises an appliance water filter manifold assembly 910 that is structured for receiving water (or another fluid), filtering the water and dispensing filtered water, e.g., for use by other components of the appliance (e.g., icemaker), for dispensing to the user 1002, etc. In this regard, the appliance water filter manifold assembly 910 comprises a manifold connector element 912. The manifold connection element 912 further comprises an electrical connector 918 that that is structured to establish an electrical connection between a connection assembly 662 of the water filter cartridge 810 and a controller 950 of the appliance 1020, via the manifold connection element 912.

The appliance 1020 typically includes the controller 950. As such, the appliance 1020, and the controller 950 in particular, is configured to perform at least a portion of the steps associated with authentication of the water filter cartridge 810 (e.g., those described with respect to FIG. 12), either based on executing computer readable instructions stored in a memory of the appliance, by causing other devices and systems (such as the water filter cartridge 810, the user device 1004, and the like) to perform one or more steps described herein, and/or based on receiving instructions, indications, or signals from other systems and devices such as the processing system 1130. In some embodiments, the processing system 1130 is configured to transmit control instructions to, and cause the controller 950 of the appliance 1020 to perform one or more steps of the embodiments presented herein. For example, the processing system 1130 may detect a trigger event (for example, determining that the filter age data is associated with the expiration of the water filter cartridge) and transmit an indication to the controller 950. In response to receiving the control signal from the system 1130, the controller 950 may initiate a presentation of a notification to the user 1002 via output devices 970 of the appliance 1020.

The controller 950 may generally refer to a device or combination of devices having circuitry used for implementing the communication and/or logic functions of the appliance 1020. For example, the controller 950 may include a control unit, a digital signal processor device, a microprocessor device, and various analog-to-digital converters, digital-to-analog converters, and other support circuits and/or combinations of the foregoing. Control and signal processing functions of the appliance 1020 may be allocated between these processing devices according to their respective capabilities. The appliance 1020 may further include various components/devices in operative communication with and/or controlled by the controller 950, such as user output devices 970, user input devices 968, a network communication interface, and the like.

A memory device of the appliance 1020 may comprises an authentication application and associated computer readable instructions. In some embodiments, the authentication application and associated computer readable instructions may be executable by the controller 950 to initiate, perform, complete, and/or facilitate one or more portions of any embodiment described and/or contemplated herein, either independently or in response to receiving control instructions from the processing system 1130.

The controller 950 may comprise a modem, a receiver, a server, a transmitter, transceiver, and/or another device for communicating with other devices and systems on the network 101. The appliance water filter manifold assembly 910 may further comprise a contact, contactless, wireless and/or wired interface that is configured to establish communication between components of the appliance 1020, between the appliance 1020, particularly the controller 950, and other devices or systems, such as the processing system 1130 and the water filter cartridge 810.

The appliance 1020 may include user input devices 968 and user output devices 970, as illustrated by FIG. 10. The user output devices 970 typically include a display (e.g., a liquid crystal display, a touchscreen display, and/or the like) which is operatively coupled to the controller 950. Other output devices may include one or more LEDs or an audio speaker, both which may indicate notifications to the user. The output devices 970 including the display typically provide instructions and information to the user, regarding authentication of the water filter cartridge. The user input devices 968 allow the appliance 1020 to transmit/receive data to/from the user, such as a keypad, keyboard, touch-screen, touchpad, microphone, mouse, joystick, other pointer device, button, soft key, and/or other input device(s). As such, in some embodiments, the user input devices 968 and/or the user output devices 970 are provided on the water filter cartridge 810, in wireline and/or wireless communication with the controller 950.

As described previously, the water filter cartridge 810 typically includes a connection assembly 662 having an electronic circuit component 882 in operative connection with a memory device 884. As discussed previously, a unique identifier associated with the water filter cartridge 810 is typically stored on the memory device 884. In some embodiments unique identifier associated with the water filter cartridge 810 may be stored on the memory device 884 in an encrypted format. In some embodiments, the electronic circuit component 882 and the memory device 884 may be are separate components that are in operative communication. In other embodiments, the electronic circuit component 882 and the memory device 884 may be an integrated unit.

In some embodiments, the memory device 884 may be a microchip. That said, the memory device may generally refer to a device or any combination of devices that store one or more forms of computer-readable media for storing data. In some embodiments, the memory device 884 comprises a non-transitory, computer readable storage medium. The memory device 884 may include any computer memory that provides an actual or virtual space to temporarily or permanently store data based on commands provided by the controller 950 when it carries out its functions described herein. In some embodiments, the memory device 884 is a secure counterfeit protection type microchip or security integrated circuit (IC). In some embodiments, the memory device 884 is a crypto authentication type microchip or security integrated circuit (IC). Here, the memory device 884 may take the form of a crypto-authentication element with having the unique identifier stored at its protected hardware based key storage. As a non-limiting example, a unique identifier having up to 16 characters/keys (or greater than up to 16 characters/keys) may be stored on the protected hardware based key storage.

In some embodiments, the connection assembly 662 comprises a processor, such as a microprocessor, which may be integral with, or separate from the electronic circuit component 882 and/or the memory device 884. The processor may be in operative communication with the electronic circuit component 882 and/or the memory device 884. The processor may be configured for executing encryption capabilities of the memory device 884 using secure hash algorithms (“SHA”) with about 256 bit key lengths.

As illustrated in FIG. 10, the processing system 1130 may include a communication device 1136, a processing device 1138, and a memory device 1140 having a processing system application 1144 and associated computer readable instructions 1142 stored therein. As shown, the processing device 1138 is operatively connected to and is configured to control and cause the communication device 1136, and the memory device 1140 to perform one or more functions. Furthermore, the processing device 1138 may be configured to control and cause the controller 950 of the appliance 1020 to perform one or more functions. In some embodiments, the processing system application 1144 comprises computer readable instructions 1142 that when executed by the processing device 1138 cause the processing device 1138 to perform one or more functions and/or transmit control instructions to the appliance 1020, the water filter cartridge 810, the authentication database 1198, to perform one or more steps described herein. The processing system 1130 may be owned by, operated by and/or affiliated with entities associated with the appliance 1020 and/or the water filter cartridge 810.

Now referring to FIG. 11 illustrating a high level process flow 1100 for a method of insertion a water filter cartridge 810 at an appliance 1020. The method of insertion typically involves providing the water filter cartridge 810 comprising a connection assembly 662 having one or more connection devices 668, as previously described. Next, the water filter cartridge 810 is inserted into a receptacle of an appliance water filter manifold assembly 910 of the appliance 1020 in a first direction, as indicated by block 1102. Typically, the first direction is associated with linear displacement from a positon outside or proximate an outer surface of the appliance water filter manifold assembly 910 towards an interior of the appliance water filter manifold assembly 910. Typically, the user 1002 inserts the water filter cartridge 810.

As indicated by block 1104, while inserting the water filter cartridge 810 (or during insertion, due to the insertion, or by the virtue of the insertion), the one or more connection devices 668 engage with one or more contacts 920 of the appliance water filter manifold assembly 910. This engagement typically involves the one or more connection devices 668 causing flexing of the one or more contacts 920 from a first position (e.g., a resting position) to a second position (e.g., a compressed position, an intermediate position, etc.), while maintaining engagement between the one or more connection devices 668 and the one or more contacts 920 during the flexing of the one or more contacts 920 from the first position to the second position. The first positon may refer to a free-state positon, a resting position, or an initial starting position of the one or more contacts 920. The second position may refer to a partial flexed or compressed position (e.g., an intermediate position) or a fully flexed or compressed position of the one or more contacts 920.

Next, the water filter cartridge 810 is partially retracted from the receptacle, in a second direction opposite to the first direction, as indicated by block 1106. Typically, in some embodiments, this partial retraction is automatic and caused by a reaction force generated at appliance water filter manifold assembly 910 by virtue of the force input by the user 1002 for inserting the water filter cartridge 810 in the first direction. This force input for insertion of the water filter cartridge 810 typically causes the elements of the appliance water filter manifold assembly 910 (e.g., flexible elements such as the one or more contacts 920, the lock mechanism 960, side locks, and/or the like.) to spring back and generate the reaction force in the second direction, opposite the first direction, thereby pushing the water filter cartridge in the second direction. Typically, the force input for insertion of the water filter cartridge 810 is greater than the generated reaction force. In addition, the linear distance traversed by the water filter cartridge 810 in the first direction due to the force input for insertion, is greater than the linear distance traversed by the water filter cartridge 810 in the opposite second direction due to the partial retraction from the reaction force. That said, in some embodiments, the user may partially retract the water filter cartridge 810.

Moreover, during the partial retraction of the water filter cartridge 810, the one or more the one or more contacts 920 flex from the second position to the third position, e.g., by the virtue of the reaction force. In some embodiments, the one or more contacts 920 flex back to the initial positon, in which case the first position is the same as the second position. In some embodiments, the one or more contacts 920 flex back only partially, to an intermediate third position that is different than the first position.

In some embodiments, the one or more contacts 920 are configured/structured to flex in order to be compatible with or allow engagement of the filter key 950 and the corresponding lock mechanism 960. At the initial insertion of the water filter cartridge 810 into the receptacle of the appliance water filter manifold assembly 910 in the first direction, the filter key 650 key engages with the lock mechanism 960. However, in order to effect locking engagement between the filter key 650 and the lock mechanism 960, the structure/design of the filter key 650 and the lock mechanism 960 may require full insertion, and then a subsequent partial retraction. In this regard, the filter key 650 and the lock mechanism 960 may be designed so that upon full insertion of the filter key 650, a spring-like reaction force arises from mechanical engagement between the filter key 650 and the lock mechanism 960, which causes a partial retraction of the filter key 650 to complete the locking engagement. Here, due to the partial retraction of the filter key 650 (and hence the water filter cartridge 810), the one or more connection devices 668 are also partially displaced in the second direction causing the one or more connection devices 668 to undesirably disengage from one or more contacts 920 of the appliance water filter manifold assembly 910, e.g., because of the incidence of a distance or gap between the one or more connection devices 668 and the one or more contacts 920. To alleviate this, the one or more contacts 920 are structured to be flexible so that the one or more contacts 920 can flex or spring back in the second direction along with the partial displacement of the one or more connection devices 668 in the second direction, so that the one or more connection devices 668 remain engaged with one or more contacts 920, even when the partial retraction occurs.

Both while the partial retraction of the water filter cartridge 810 is ongoing and after the partial retraction is complete, the one or more connection devices 668 maintain engagement with the one or more contacts 920, as indicated by block 1108. In other words, the one or more connection devices 668 maintain engagement the one or more contacts 920 during the flexing of the one or more contacts 920 from the second position to the third position. Also, the one or more connection devices 668 and the one or more contacts 920 are in engagement following completion of the partial retraction of the water filter cartridge 810. The engagement described herein may refer to both mechanical and electrical engagement, such that operative communication may occur between the water filter cartridge 810 and the controller 950, via the appliance water filter manifold assembly 910.

Here, an electrical communication link is established between a memory device of the connection assembly 662 and the appliance water filter manifold assembly 910.

In some embodiments, the planar face of the end cap component 890 is positioned flush with an outer surface of the appliance water filter manifold assembly 910, after the insertion is complete.

A method of removal of this assemble water filter will now be described. Here, the water filter cartridge 810 is first partially displaced in the first direction such that the water filter cartridge 810 is linearly displaced in the first direction. Typically, the user may initiate this linear displacement by applying a force onto the second portion 615 of the water filter cartridge 810 (e.g., on the planar face of the end cap component 890) along the first direction, to partially displace the water filter cartridge 810. While partially displacing the water filter cartridge 810 (or during, due to the, or by the virtue of the partial displacement), a force is applied onto the one or more contacts 920 of the appliance water filter manifold assembly 910 in the first direction. Moreover, this force in the first direction causes the lock mechanism 960 to move to an unlocked position, so that the water filter cartridge can be withdrawn.

In response, a reaction force at elements of the appliance water filter manifold assembly 910 (e.g., flexible elements such as the one or more contacts 920, side locks, etc.) to spring back and generate the reaction force in the second direction, opposite the first direction, thereby pushing the water filter cartridge 810 in the second direction. This reaction force causes linear displacement of the water filter cartridge 810 in the second direction such that at least a portion of the water filter cartridge 810 (e.g., the second portion 615 of the water filter cartridge 810) protrudes out of the receptacle. The water filter cartridge 810 may then be withdrawn from the receptacle by accessing the protruding portion of the water filter cartridge.

Now referring to FIG. 12 illustrating a high level process flow 1200 for a method for authentication of a water filter cartridge 810 at an appliance 1020. In some embodiments, some or all of the steps described herein are performed by the processing device 1138 of the processing system 1130, e.g., in response to executing the computer readable instructions 1142. In some embodiments, some or all of the steps described herein are performed by the controller of the appliance 1020, e.g., based on instructions stored by the appliance 1020 and/or in response to receiving instructions from the processing system 1130. In some embodiments, the water filter cartridge 810 is first inserted into the receptacle in accordance with the process flow 1100 of FIG. 11.

As indicated by block 1202, an electrical communication link is established between the memory device 884 of a water filter cartridge 810 and the controller 950, via the appliance water filter manifold assembly 910 of the appliance and the electronic circuit component 882 of the water filter cartridge 810. The controller 950 may then retrieve, at step 1204, a unique identifier stored on the memory device 884 of the water filter cartridge 810. The unique identifier is configured for (i) uniquely identifying the water filter cartridge 810, (ii) determining compatibility of the water filter cartridge 810 with the appliance 1020, (iii) determining its expiration, and/or (iv) tracking the lifecycle and usage of the water filter cartridge 810 through its lifetime. The system may also retrieve any filter age data stored on the memory device 884 of the water filter cartridge 810. This filter age data may comprise usage data of the water filter cartridge 810 (e.g., volume of water filtered to date, time period/duration of usage to date, date of first usage of the water filter cartridge 810, number of appliances that the water filter cartridge 810 has been utilized in to date, water quality data (e.g., pH, salinity of water input, contamination conditions encountered, other water quality indicators, a combination of the foregoing, etc.), and/or the like), expiration data (e.g., life span time period of the water filter cartridge 810, expiration date (or use by date) of the water filter cartridge 810, and/or the like), and/or other data. In some embodiments, the memory device 884 is a passive device, and is powered by the appliance water filter manifold assembly 910 upon assembly, allowing for reading and/or writing of data therefrom. In other embodiments, the memory device 884 is an active device having its own power source.

In some embodiments, the filter data determined or retrieved in the manner described above, may be presented to the user (e.g., upon validation of the water filter cartridge 810, described below). Non limiting examples of the filter data presented to the user can include one or more of: the unique identifier stored on the memory device 884 of the water filter cartridge 810, determined compatibility of the water filter cartridge 810 with the appliance 1020, determined expiration, tracked lifecycle and usage of the water filter cartridge 810 through its lifetime, filter age data comprising usage data of the water filter cartridge 810 (e.g., volume of water filtered to date, time period/duration of usage to date, date of first usage of the water filter cartridge 810, number of appliances that the water filter cartridge 810 has been utilized in to date, water quality data (e.g., pH, salinity of water input, contamination conditions encountered, other water quality indicators, a combination of the foregoing, etc.), and/or the like), expiration data (e.g., life span time period of the water filter cartridge 810, expiration date (or use by date) of the water filter cartridge 810, and/or the like), and/or other data. Moreover, the filter data may be presented to the user, either at the user device 1004 or at output devices 970 of the appliance 1020. In the instances where the filter data is displayed at the user device 1004, the filter data may be presented via interfaces of the one or more user device applications 1122, such as a mobile device application (e.g., a dedicated appliance application stored on the user device 1004, with the user device 1004 being a mobile device, a smart phone, etc.), a browser application, a desktop application, etc.

As indicated by block 1205, the unique identifier is then validated. Here, in some embodiments, the controller 950 transmits the extracted unique identifier to the processing system 1130. The processing system 1130 may then directly, or based on communication with the authentication database 1198, determine whether the extracted unique identifier of the water filter cartridge 810 is associated with a previously stored (e.g., at the authentication database) and/or validated unique identifier. The processing system 1130 may also extract water filter attributes associated with the unique identifier, such as type of compatible appliances (e.g., appliance model numbers), filter age data filter age (e.g., usage data of the water filter cartridge 810 such as volume of water filtered to date, time period/duration of usage to date, date of first usage of the water filter cartridge 810, number of appliances that the water filter cartridge 810 has been utilized in to date, etc., expiration data such as life span time period of the water filter cartridge 810, expiration date (or use by date) of the water filter cartridge 810, and/or the like) e.g., from the authentication database. That said, it is understood that, in other embodiments, the controller 950 may perform these functions instead of the processing system 1130.

A first scenario of authenticating the water filter cartridge 810 will now be described. Here, as indicated by block 1206, the processing system 1130 may determine that the unique identifier is a valid unique identifier. Here, for validating the water filter cartridge 810 for use in the appliance 1020, the system may ascertain that (i) the unique identifier is associated with an authentic water filter cartridge, (ii) that the water filter cartridge 810 is compatible with the appliance 1020, and/or (iii) that water filter cartridge 810 has not expired (e.g., based on the filter age data). In other embodiments, for validating the water filter cartridge 810 for use in the appliance 1020, the system may ascertain that (i) the unique identifier is associated with a bypass type water filter cartridge. A bypass type water filter cartridge may be configured to allow the water flow through the appliance water filter manifold assembly 910 to bypass the water filter cartridge. Such a bypass type water filter cartridge may be employed when the appliance is associated with an external filtration system that provides filtered water to the appliance, for the purposes of testing and/or repair of the appliance, etc.

In some embodiments, for determining whether the water filter cartridge 810 has expired and/or for determining that the water filter cartridge needs to be replaced, the system is configured to determine an expiration date for the water filter. In some embodiments, the system may determine the expiration date based on filter based on at least the filter age data described above. In some embodiments, the system may determine the expiration date based on usage data of the water filter cartridge 810 such as, but not limited to, volume of water filtered to date, time period/duration of usage to date, date of first usage of the water filter cartridge 810, number of appliances that the water filter cartridge 810 has been utilized in to date, etc. In some embodiments, the system may determine the expiration date based on water quality data such as, but not limited to, pH, salinity of water input, contamination conditions encountered, other water quality indicators, a combination of the foregoing, etc. This water quality data may be associated with prior or current water quality. In some embodiments, the system may determine the expiration date based on expiration data (e.g., stored on the memory device 884) of the water filter cartridge 810 such as, but not limited to, life span time period of the water filter cartridge 810, expiration date (or use by date) of the water filter cartridge 810, and/or the like), and/or other data.

In response to validating the water filter cartridge 810, the processing system 1130 may then authenticate the water filter cartridge 810 for use in the appliance 1020, and transmit a control signal to the controller 950 that causes the appliance 1020 to commence use of the water filter cartridge 810, as indicated by block 1207. In the embodiments, were the controller 950 validates the unique identifier, the controller may commence use of the water filter cartridge 810 upon validation in a similar manner. Moreover, a notification may be displayed for the user, either at the user device 1004 or at output devices 970 of the appliance 1020, indicating that the water filter cartridge 810 has been authenticated for use in the appliance. In the instances where the notification is displayed at the user device 1004, the notification may be presented via interfaces of the one or more user device applications 1122, such as a mobile device application (e.g., a dedicated appliance application stored on the user device 1004, with the user device 1004 being a mobile device, a smart phone, etc.), a browser application, a desktop application, etc.

A second scenario of non-authenticating the water filter cartridge 810 will now be described. Here, as indicated by block 1208, the processing system 1130 (or controller 950) may determine that the unique identifier is not valid unique identifier. Here, for unsuccessful validation of the water filter cartridge 810 for use in the appliance 1020, the system may ascertain that (i) the unique identifier is not associated with an authentic water filter cartridge, (ii) that the water filter cartridge 810 is not compatible with the appliance 1020, and/or (iii) that water filter cartridge 810 has expired (e.g., based on the filter age data). In response, the processing system 1130 may transmit a control signal to the controller 950 indicating that the water filter cartridge 810 is not authentic. In this regard, as indicated by block 1209, one or more actions may be performed. In some embodiments, performing the action involves the controller 950 causing modification of a flow of water to the water filter cartridge 810 from the appliance water filter manifold assembly 910, such as restricting the flow, reducing the volume flow rate of the water, stopping the flow of water, etc. In some embodiments, performing the action involves the controller 950 causing the water flow (e.g., from a water source, or tank associated with the appliance) to bypass the water filter cartridge 810 and divert the flow to another component of the appliance (e.g., an icemaker, a water dispenser, etc.). In some embodiments, performing the action involves the controller 950 causing the modification of the functions of other components of the appliance (e.g., an icemaker, a water dispenser, etc. that are downstream from the appliance water filter manifold assembly 910), such as stopping dispensing of water, stopping the icemaker, etc. In some embodiments, performing the action involves presenting, by the controller 950 and/or by the processing system 1130, a notification for the user, either at the user device 1004 or at output devices 970 of the appliance 1020, indicating that the water filter cartridge 810 has not been authenticated for use.

In some embodiments, performing the action involves transmitting a notification to an appliance manufacturer that that the indicating that the water filter cartridge 810 has not been authenticated for use. Here, in the instances where the processing system 1130 is owned by, operated by or otherwise associated with a manufacturer of the appliance 1020, the controller 950 may transmit the notification indicating the unsuccessful authentication to the processing system 1130. In the instances where the processing system 1130 is not owned by, operated by or otherwise associated with a manufacturer of the appliance 1020, the controller 950 and/or the processing system 1130 may transmit the notification indicating the unsuccessful authentication to another system associated with the appliance manufacturer.

The feature of dynamic monitoring of the use of the water filter cartridge 810 will now be described. Typically, the controller 950 continuously monitors the usage of the water filter cartridge 810 (e.g., in the form of usage parameters like volume or volume flow rate of water input into the water filter cartridge 810, volume or volume flow rate flow rate of filtered water output by water filter cartridge 810, a run-time of the water filter cartridge 810, etc.). In this regard, the controller 950 may operate one or more timers to determine the usage parameters. The controller 950 may determine usage parameters, such as a run-time of the water filter cartridge 810 (e.g., time elapsed since first use, time elapsed since usage in the current appliance, etc.), and transmit and store the determined usage parameters on the memory device 884 of the water filter cartridge 810. The controller may transmit and store the determined usage parameters continuously in real-time, after every cycle, intermittently, at predetermined time intervals, or at any other suitable time.

In some embodiments, the controller 950 and/or the processing system 1130 may transmit the determined usage parameters to the user. Specifically, in some embodiments, the controller 950 and/or the processing system 1130 may determine a volume of filtered water dispensed to the user 1002 by the appliance 1020 for a predetermined interval of time such as 24 hours, e.g., based on at least determining a volume of filtered water output by the water filter cartridge 810 during use during the predetermined interval of time. The controller 950 and/or the processing system 1130 may then present the volume of filtered water dispensed to the user 1002 by the appliance 1020, indicating the user's water consumption. In this manner, the invention may facilitate the user 1002 to track hydration goals.

Moreover, in some embodiments, during use of the water filter cartridge 810, the system may determine that the current filter age data indicates that (i) the water filter cartridge 810 has expired, or that (ii) the water filter cartridge 810 is set to expire within a subsequent time period. In this regard, based on the current filter age data, the system may determine that an expiration date of the water filter cartridge 810 occurs within a subsequent time period, that the volume of water filtered to date is greater than a predetermined threshold, that a total time period/duration of usage to date is greater than a predetermined threshold, and/or the like. In response, the controller 950 and/or by the processing system 1130, may present a notification for the user, either at the user device 1004 or at output devices 970 of the appliance 1020, indicating that the water filter cartridge 810 has expired or that is set to expire as the case may be, and/or indicating the user to replace the water filter cartridge.

The features of the notifications presented to the user will now be described. The notifications may comprise one or more of (i) causing a display device to present a text associated with the current status (e.g., expiration, authentication, etc. in the form of texts, emails, illumination of lighting devices (such as LEDs) arranged a shape associated with the text, etc.) of the water filter cartridge 810, (ii) causing a lighting device (e.g., LED) to display illumination or light of a certain frequency spectrum that is associated with current status (e.g., red light for expiration, green light authentication, light having an intensity greater that a predetermine threshold for expiration, etc.) of the water filter cartridge 810, and/or (iii) causing a speaker device to produce an audio output that is associated with current status (e.g., sound at a volume/pitch/tone above a threshold for expiration, sound at a volume/pitch/tone below a threshold for authentication, etc.) of the water filter cartridge 810. As such the display device, the lighting device and the speaker device may be a part of the output devices 920 of the appliance 1020 and/or they may be a part of the output devices 1010 of the user device 1004. Moreover, the user 1002 is able to configure the notifications on a scale of less intrusive or gentle to obtrusive. Less intrusive or gentle notifications may include low frequency sounds, low intensity light, text message alerts at time intervals greater that a predetermines threshold, etc., while obtrusive notifications may include high frequency sounds, high intensity light, text message alerts at time intervals lower that the predetermines threshold, etc.

Moreover, the invention allows the user to temporarily halt the notifications. Here, upon presenting a first notification at a first time, the user 1002 may provide an input to temporarily suspending the notification for an intermission time, either via the input devices 968 of the appliance or via the user device 1004. In response to receiving the user input, the controller 950 and/or the processing system 1130 may then (i) stop the presentation of the first notification and (ii) activate a timer associated with a countdown of the intermission time. When the intermission time elapses, the controller 950 and/or the processing system 1130 may present a second notification to the user 1002 at a second time.

Now referring to FIG. 13 illustrating a high level process flow 1300 for a method of use of a water filter cartridge 810 at an appliance 1020. In some embodiments, some or all of the steps described herein are performed by the processing device 1138 of the processing system 1130, e.g., in response to executing the computer readable instructions 1142. In some embodiments, some or all of the steps described herein are performed by the controller of the appliance 1020, e.g., based on instructions stored by the appliance 1020 and/or in response to receiving instructions from the processing system 1130.

In some embodiments, a water filter cartridge is provided. as indicated by block 1302. This water filter cartridge is substantially similar to the water filter cartridge 810 described with respect to FIGS. 8-12 previously. Typically, the water filter cartridge 810 comprises a water inlet port and a water outlet port, as described above.

As indicated by block 1304, the water filter cartridge 810 is inserted into the receptacle of the appliance water filter manifold assembly, as described with respect to the process flow 1100 of FIG. 11 previously. In some embodiments, the water filter cartridge 810 is inserted into the receptacle of the appliance water filter manifold assembly by the user.

As discussed previously, one or more connection devices 668 of the water filter cartridge 810 are structured for engaging an electrical connector 918 (illustrated in FIG. 9) of an appliance water filter manifold assembly of an appliance, to establish an electrical connection between the connection assembly 662 and the controller of the appliance. The one or more connection devices 668 may be substantially similar to the circuit pads 40 and 140 described previously. The electrical connector 918 is substantially similar to the wire harness (10, 110) described previously. Moreover, the electrical connector 918 (10, 110) comprises one or more contacts 920 that may be substantially similar to contacts (22, 122) with curved contact sections (38, 138) described previously.

Next, as indicated by block 1306, a notification associated with the authentication of the water filter cartridge (e.g., in response to retrieving a unique identifier stored on the water filter cartridge 810). Typically, this notification is similar to those described previously with respect to process flow 1200 of FIG. 12 previously. In some embodiments, the user receives the notification. As discussed previously, the notification associated with the water filter cartridge comprises one or more of an indication associated with (i) successful authentication of the water filter cartridge, (ii) unsuccessful authentication of the water filter cartridge, and/or (iii) activation of the water filter cartridge for use at the appliance. In some embodiments, activating the water filter cartridge 810 for use at the appliance, may refer to configuring the water filter cartridge 810 for use at the appliance 1020 and/or commencing use of the water filter cartridge 810 at the appliance 1020 (e.g., by initiating flow of water through the water filter cartridge 810).

As such, the notification may take the form of one or more of (i) a text, (ii) a light of a frequency spectrum, and/or (iii) an audio output associated with the expiration of the water filter cartridge. Moreover, the notification may be displayed for the user, either at the user device 1004 or at output devices 970 of the appliance 1020, indicating that the water filter cartridge 810 has been authenticated for use in the appliance, that the water filter cartridge 810 has been activated for use at the appliance and/or that the water filter cartridge 810 has not been authenticated for user in the appliance.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation. In addition, where possible, any terms expressed in the singular form herein are meant to also include the plural form and/or vice versa. As used herein, “at least one” shall mean “one or more” and these phrases are intended to be interchangeable. Accordingly, the terms “a” and/or “an” shall mean “at least one” or “one or more,” even though the phrase “one or more” or “at least one” is also used herein.

What is claimed:

1. A method of insertion of a water filter cartridge at an appliance, comprising:
providing the water filter cartridge comprising a connection assembly having one or more connection devices;
inserting the water filter cartridge into a receptacle of an appliance water filter manifold assembly of the appliance in a first direction;
while inserting, engaging the one or more connection devices with one or more contacts of the appliance water filter manifold assembly such that the one or more connection devices (i) cause flexing of the one or more contacts from a first position to a second position and (ii) maintain engagement with the one or more contacts during the flexing of the one or more contacts from the first position to the second position;
partially retracting the water filter cartridge in a second direction opposite to the first direction such that the one or more contacts flex from the second position to a third position; and
while partially retracting, maintaining engagement between the one or more connection devices and the one or more contacts during the flexing of the one or more contacts from the second position to the third position; and
wherein the one or more connection devices and the one or more contacts are in engagement following completion of the partial retraction of the water filter cartridge.

2. The method of claim 1, wherein each of the one or more connection devices comprises a connection surface structured such that the connection surface maintains an engagement with the one or more contacts during flexing of the one or more contacts.

3. The method of claim 1, further comprising, while inserting, engaging a filter key of the water filter cartridge with a locking mechanism of the appliance water filter manifold assembly.

4. The method of claim 3, wherein the filter key of the water filter cartridge engages the locking mechanism of the appliance water filter manifold assembly such that the filter key causes a pair of opposing side locks of the spring lock mechanism to diverge from each other.

5. The method of claim 3, wherein, upon completion of the partial retraction, the filter key of the water filter cartridge is in mechanical engagement with the locking mechanism of the appliance water filter manifold assembly.

6. The method of claim 1, further comprising:
establishing an electrical communication link between a memory device of the connection assembly and the appliance water filter manifold assembly.

7. The method of claim 1, wherein the one or more connection devices engage with the one or more contacts such that one or more connection devices are positioned in mechanical and electrical engagement with curved contact sections of substrate engagement sections of the one or more contacts, wherein the substrate engagement sections extend from compliant sections of the one or more contacts, wherein the compliant sections extend from termination sections of the one or more contacts, wherein the termination sections are mounted on an electrical connector of the appliance water filter manifold assembly.

8. The method of claim 1, wherein the first position of the one or more contacts is the same as the third position of the one or more contacts.

9. A method of removal of a water filter cartridge from an appliance, comprising:
inserting the water filter cartridge at the appliance in accordance with the method of claim 1, such that the one or more connection devices and the one or more contacts remain in engagement after inserting the water filter cartridge;
partially displacing the water filter cartridge in the first direction such that the water filter cartridge is linearly displaced in the first direction;
while partially displacing, applying, by the one or more connection devices, a force onto the one or more contacts of the appliance water filter manifold assembly in the first direction, wherein applying the force is structured to cause automatic partial displacement of the water filter cartridge in the second direction opposite to the first direction; and
withdrawing the water filter cartridge from the receptacle of the appliance water filter manifold assembly.
